(19) United States
(12) Patent Application Publication
(10) Pub. No.: US 2019/0039380 A1
(43) Pub. Date: Feb. 7, 2019

(54) LIQUID SUPPLY UNIT

(71) Applicant: Seiko Epson Corporation, Tokyo (JP)

(72) Inventors: Satoshi SHINADA, Shiojiri-shi (JP); Taku ISHIZAWA, Matsumoto-shi (JP); Yoshiaki SHIMIZU, Matsumoto-shi (JP); Noriyuki FUKASAWA, Shiojiri-shi (JP)

(73) Assignee: Seiko Epson Corporation, Tokyo (JP)

(21) Appl. No.: 16/065,549

(22) PCT Filed: Nov. 18, 2016
(86) PCT No.: PCT/JP2016/084226

§ 371 Date: Jun. 22, 2018

(30) Foreign Application Priority Data
Nov. 18, 2016 (JP) 2015-256018

(51) Int. Cl. B41J 2/175

(52) U.S. Cl. CPC B41J 2/1753; B41J 2/17546; B41J 2/17553; B41J 2/1752

(57) ABSTRACT

An object is to suppress reduction of the stability of electrical connection between a liquid ejection apparatus and a liquid supply unit. A liquid supply unit (20) configured to be mountable to a liquid ejection apparatus (50) that has a first electrode (930a) and a second electrode (930b) comprises a first contact portion (cpb) configured to be in contact with the first electrode (930a) in a state that the liquid supply unit (20) is mounted to the liquid ejection apparatus (50); a second contact portion (cpb) configured to be in contact with the second electrode (930b) in the state that the liquid supply unit is mounted to the liquid ejection apparatus (50); and a wall portion (40) configured such that the first contact portion (cpb) and the second contact portion (cpb) are placed therein. The first contact portion (cpb) is placed on a first wall face (S1) of the wall portion (40), and the second contact portion (cpb) is placed on a second wall face (S2) of the wall portion that is on an opposite side to the first wall face (S1).

### CROSS-REFERENCE TO RELATED APPLICATIONS

This application is a National Stage Entry of International Appl. No. PCT/JP2016/084226, filed Nov. 18, 2016; which claims priority to Japanese Appl. No. 2015-256018 filed Dec. 28, 2015; the disclosures of both of which are incorporated by reference herein in their entirety.

### FIELD

The present disclosure relates to a liquid supply unit configured to supply a liquid to a liquid ejection apparatus.

### BACKGROUND

An ink cartridge (hereinafter may be simply referred to as “cartridge”) provided with a small-size circuit board may be used as a cartridge to supply ink to an inject printer (hereinafter may be simply referred to as “printer”) (as described in Patent Literature 1). This circuit board is used to store information regarding ink, for example, information regarding the color of ink contained in the cartridge and to notify the inkjet printer of such information. The circuit board is also used to cause a printer main body to detect mounting of the cartridge to a cartridge holder (hereinafter may be simply referred to as “holder”) provided in the inkjet printer. For such applications, a plurality of electrically conductive contact portions (terminals) corresponding to the types of applications are provided on the surface of the circuit board. When the cartridge is mounted to the holder, the respective contact portions of the circuit board come into contact with corresponding electrodes on the holder side to provide electrical continuity.

### CITATION LIST

### Patent Literature

PTL 1; JP 2013-60002A

### SUMMARY

### Technical Problem

In an on-carriage-type printer, the cartridge is mounted on a carriage. The carriage reciprocates in a scanning direction, and ink is ejected from a print head mounted on the carriage. In such an on-carriage-type printer, there may be a positional misalignment of the contact portion of the circuit board relative to the electrode of the holder due to vibration in the course of acceleration or deceleration of the carriage. In an off-carriage-type printer, on the other hand, the cartridge is fastened and mounted to a different portion of the printer main body other than the carriage and does not reciprocate. There may be, however, still a positional misalignment of the contact portion of the circuit board relative to the electrode of the holder due to vibration accompanied with printing, for example, vibration accompanied with reciprocating motions of the carriage. The positional misalignment of the contact portion of the circuit board relative to the electrode of the holder reduces the stability of electrical connection between the cartridge and the printer. This may cause problems, for example, a failure in obtaining the information regarding ink and misdetection of mounting or non-mounting of the cartridge or the remaining amount of ink. Additionally, a short circuit between the contact portions due to a foreign substance such as dust or ink droplets adhering to the contact portions of the circuit board reduces the stability of electrical connection between the cartridge and the printer. The above problems are also likely to arise in this case.

Such problems are not limited to the printer but may also arise in any liquid ejection apparatus configured to eject a liquid. Such problems are also not limited to the cartridge but may arise in any liquid supply unit that is mountable to the liquid ejection apparatus. Such problems are also similarly found in a configuration that contact portions are provided on the surface of a case of the cartridge, in place of the circuit board. There is accordingly a demand for a technique that suppresses reduction of the stability of electrical connection between the liquid ejection apparatus and the liquid supply unit.

### Solution to Problem

The present disclosure may be implemented by aspects described below, in order to solve at least part of the above problems.

(1) According to one aspect of the present disclosure, there is provided a liquid supply unit configured to be mountable to a liquid ejection apparatus that includes a first electrode and a second electrode. The liquid supply unit comprises: a first contact portion configured to be in contact with the first electrode in a state that the liquid supply unit is mounted to the liquid ejection apparatus; a second contact portion configured to be in contact with the second electrode in the state that the liquid supply unit is mounted to the liquid ejection apparatus; and a wall portion configured such that the first contact portion and the second contact portion are placed therein. The first contact portion is placed on a first wall face of the wall portion, and the second contact portion is placed on a second wall face of the wall portion that is on an opposite side to the first wall face.

In the liquid supply unit of this aspect, the first contact portion and the second contact portion are separately placed on the first wall face and on the second wall face that are faces of the wall portion opposite to each other. This configuration allows for increases in area of the first contact portion and area of the second contact portion that are respectively in contact with the first electrode and with the second electrode, compared with a configuration that the first contact portion and the second contact portion are placed on one identical face. This configuration accordingly suppresses reduction of the stability of electrical connection between the liquid ejection apparatus and the liquid supply unit even in the case of a positional misalignment of the liquid supply unit relative to the liquid ejection apparatus. Additionally, the configuration that the first contact portion and the second contact portion are separately arranged on the first wall face and on the second wall face that are faces opposite to each other suppresses a short circuit between the first contact portion and the second contact portion due to a liquid that is ejected from the liquid ejection apparatus and that adheres to both the first contact portion and the second contact portion. This configuration accordingly suppresses reduction of the stability of electrical connection between the liquid ejection apparatus and the liquid supply unit.

(2) The liquid supply unit of the above aspect may further comprise a liquid container portion. The second electrode may be placed between the liquid container portion and the wall portion in the state that the liquid supply unit is mounted to the liquid ejection apparatus. In the liquid supply unit of this aspect, the second electrode is located between the liquid container portion and the wall portion in the state that the liquid supply unit is mounted to the liquid ejection apparatus. This configuration causes at least the second contact portion to be separated from outside of the liquid supply unit by the liquid container portion. This configuration accordingly suppresses the ejected liquid or any foreign substance such as dust from adhering to the second contact portion.

(3) The liquid supply unit of the above aspect may further comprise: a first face; a second face opposed to the first face;

a third face arranged to intersect with the first face and the second face; a fourth face arranged to intersect with the first face and the second face and opposed to the third face; a fifth face arranged to intersect with the first face, the second face, the third face and the fourth face; a sixth face arranged to intersect with the first face, the second face, the third face and the fourth face and opposed to the fifth face; a liquid supply portion formed on the first face and configured to supply a liquid to the liquid ejection apparatus; and a restricting portion formed on the fifth face and configured to restrict an attitude of the liquid supply unit in a process of mounting the liquid supply unit to the liquid ejection apparatus. The wall portion may form at least part of the fifth face. When the liquid supply unit is viewed in a direction from the first face toward the second face, the liquid supply portion may be located nearer to the fifth face than the sixth face. The first contact portion and the second contact portion may be both located between the liquid supply portion and the restricting portion. In the liquid supply unit of this aspect, when the liquid supply unit is viewed in the direction from the first face toward the second face, the first contact portion and the second contact portion are both located between the liquid supply portion and the restricting portion. This configuration takes advantage of the effect of improving the position accuracy by the restricting portion to further improve the position accuracy of the first contact portion and the second contact portion, compared with a configuration that these contact portions are placed at positions that are farther away from the restricting portion relative to the liquid supply portion.

(4) The liquid supply unit of the above aspect may further comprise a case including the first face to the sixth face. The case may include a placing portion that is open at least to the first face and that is configured to place the second electrode therein in the state that the liquid supply unit is mounted to the liquid ejection apparatus. The liquid supply unit of this aspect includes the placing portion that is open to the first face and is configured to place the second electrode therein in the state that the liquid supply unit is mounted to the liquid ejection apparatus. This configuration enables the second electrode to be placed in the placing portion and enables the second electrode to come into contact with the second contact portion, simultaneously with the operation of mounting the liquid supply unit to the liquid ejection apparatus. This configuration enables the liquid supply unit to be mounted more readily or in a shorter time period, compared with a configuration that these two operations (mounting operation and contact operation) are performed separately.

(5) In the liquid supply unit of the above aspect, the placing portion may be further open to the third face. In the liquid supply unit of this aspect, the placing portion is open to the third face in addition to the first face. This configuration facilitates maintenance, for example, removal of any foreign substance adhering to inside of the placing portion, by using this third face.

(6) In the liquid supply unit of the above aspect, the placing portion may be further opening to the fourth face. The liquid supply unit of this aspect facilitates maintenance, for example, removal of any foreign substance adhering to inside of the placing portion.

(7) In the liquid supply unit of the above aspect, an opening of the placing portion formed in at least one of the third face and the fourth face may be arranged to be continuous with an opening of the placing portion formed in the first face. In the liquid supply unit of this aspect, the opening formed in at least one of the third face and the fourth face is arranged to be continuous with the opening of the placing portion formed in the first face. This configuration enables the second electrode to be readily inserted into the placing portion and further facilitates maintenance, for example, removal of any foreign substance adhering to inside of the placing portion.

(8) In the liquid supply unit of the above aspect, the case may have a wall that includes a piercing portion formed to be open to the fifth face and to communicate with the placing portion and that forms at least part of the fifth wall. The wall portion may be configured by a circuit board having the first wall face and the second wall face. At least part of the circuit board in a thickness direction may be placed in the piercing portion. The first wall face may form part of the fifth face. In the liquid supply unit of this aspect, at least part of the circuit board in the thickness direction is placed in the piercing portion. A positional misalignment of the part placed in the piercing portion is restricted by an inner wall of a piercing portion. This configuration accordingly suppresses a positional misalignment of the circuit board. This configuration also achieves downsizing of the liquid supply unit, compared with a configuration that the circuit board is not at all placed in the wall (piercing portion).

(9) The liquid supply unit of the above aspect may comprise a plurality of the first contact portions. Number of the first contact portions may be larger than number of the second contact portions. In the liquid supply unit of this aspect, the number of the first contact portions is larger than the number of the second contact portions. This causes a total force transferred from the first electrode to the first contact portion to be larger than a total force transferred from the second electrode to the second contact portion. This causes the force applied to the circuit board to be in the direction from the first electrode toward the second electrode and thereby suppresses the circuit board from coming off from the wall.

(10) The liquid supply unit of the above aspect may further comprise a storage unit placed on the second wall face. The second contact portion may be used for power supply to the storage unit. In the liquid supply unit of this aspect, the second contact portion used for power supply is placed to face the placing portion. This configuration suppresses a short circuit of the second contact portion and suppresses overcurrent from flowing in a circuit for power supply to damage or break this circuit.

(11) In the liquid supply unit of the above aspect, a distance between the first contact portion and the first face may be equal to a distance between the second contact portion and the first face in the state that the liquid supply unit is mounted to the liquid ejection apparatus. In the liquid supply unit of this aspect, the distance between the first contact portion and the first face is equal to the distance between the second contact portion and the first face. This causes the position of the first contact portion to be flush with the position of the second contact portion in a direction perpendicular to the thickness direction of the wall portion (i.e., direction from the first face toward the second face). This configuration enables at least part of the force applied from the first electrode and at least part of the force applied from the second electrode to be cancelled each other and thereby suppresses a positional misalignment of the wall portion by these forces.

(12) The liquid supply unit of the above aspect may further comprise a third contact portion configured to be in contact with the first electrode in the state that the liquid supply unit is mounted to the liquid ejection apparatus. A distance between the first contact portion and the first face, a distance between the second contact portion and the first face, and a distance between the third contact portion and the first face in the state that the liquid supply unit is mounted to the liquid ejection apparatus are respectively expressed as a first distance, a second distance and a third distance, the second distance may be larger than the first distance and may be smaller than the third distance. In the liquid supply unit of this aspect, the second distance is larger than the first distance and is smaller than the third distance. This configuration enables the first contact portion, the second contact portion and the third contact portion to be placed in this sequence from the first face toward the second face in the direction perpendicular to the thickness direction of the wall portion (i.e., in the direction from the first face toward the second face). This configuration enables the force from the first electrode and the force from the second electrode to be applied to the wall portion in a balanced manner in the direction perpendicular to the thickness direction of the wall portion and thereby suppresses a positional misalignment of the wall portion by these forces.

(13) The liquid supply unit of the above aspect may further comprise; a first face; a second face opposed to the first face; a third face arranged to intersect with the first face and the second face; a fourth face arranged to intersect with the first face and the second face and opposed to the third face; a fifth face arranged to intersect with the first face, the second face, the third face and the fourth face; a sixth face arranged to intersect with the first face, the second face, the third face and the fourth face and opposed to the fifth face; and a liquid supply portion formed on the first face and configured to supply a liquid to the liquid ejection apparatus. The wall portion may be placed on the first face. The first wall face of the wall portion may face in a direction from the third face toward the fourth face, and the second wall face of the wall portion may face in a direction from the fourth face toward the third face. The liquid supply unit of this aspect includes the first face to the sixth face. This configuration suppresses reduction of the stability of electrical connection between the liquid supply unit and the liquid supply unit that is configured such that the wall portion is placed on the first face.

All the plurality of components included in each of the aspects of the disclosure described above are not essential, but some components among the plurality of components may be appropriately changed, omitted or replaced with other additional components or part of the limitations may be deleted, in order to solve part or all of the problems described above or in order to achieve part or all of the advantageous effects described herein. In order to solve part or all of the problems described above or in order to achieve part or all of the advantageous effects described herein, part or all of the technical features included in one aspect of the disclosure described above may be combined with part or all of the technical features included in another aspect of the disclosure described above to provide one independent aspect of the disclosure.

The present disclosure may be implemented by various aspects. For example, the present disclosure may be implemented by aspects of a manufacturing method of the liquid supply unit, a manufacturing method of a liquid ejection apparatus, an ink cartridge, and a printer equipped with an ink cartridge mounted thereon.

### BRIEF DESCRIPTION OF DRAWINGS

FIG. 1 is a perspective view illustrating the schematic configuration of a printer equipped with ink cartridges as an application of the liquid supply unit according to an embodiment of the present disclosure;

FIG. 2 is an appearance perspective view illustrating a cartridge;

FIG. 3 is a bottom view illustrating the cartridge;

FIG. 4 is an appearance perspective view illustrating the cartridge in the state that a circuit board is detached;

FIG. 5 is a side view illustrating the cartridge in the state that the circuit board is detached;

FIG. 6 is a sectional diagram illustrating an A-A section of the cartridge shown in FIG. 4;

FIG. 7 is a perspective view illustrating closeup of the configuration in the periphery of a placing portion of the cartridge in the state that the circuit board is detached;

FIG. 8 is a perspective view illustrating the detailed configuration of a surface of the circuit board;

FIG. 9 is a perspective view illustrating the detailed configuration of a rear face of the circuit board;

FIG. 10 is a perspective view illustrating the detailed configuration of a carriage;

FIG. 11 is a front view illustrating the detailed configuration of an outside electrode holder;

FIG. 12 is a front view illustrating the detailed configuration of an inside electrode holder;

FIG. 13 is a sectional view illustrating the configuration of the cartridge and a holder in a mounted state;

FIG. 14 is a diagram illustrating the detailed configuration of the circuit board, the outside electrode holder and the inside electrode holder in the mounted state;

FIG. 15 is a diagram schematically illustrating the contact state of the circuit board with a holder-side electrode assembly in the mounted state;

FIG. 16 is a side view illustrating a first aspect of the ink cartridge according to a modification of the first embodiment;

FIG. 17 is a sectional view illustrating part of a section of a cartridge according to the first aspect of the modification;

FIG. 18 is a perspective view illustrating closeup of a configuration near to a placing portion of the cartridge in the state that the circuit board is detached according to the first aspect of the modification;

FIG. 19 is a side view illustrating a second aspect of the ink cartridge according to a modification of the first embodiment;

FIG. 20 is a sectional view illustrating part of a section of a cartridge according to the second aspect of the modification;

FIG. 21 is a perspective view illustrating closeup of a configuration near to a placing portion of the cartridge in the state that the circuit board is detached according to the second aspect of the modification of the first embodiment;

FIG. 22 is a side view illustrating a third aspect of the ink cartridge according to a modification of the first embodiment;

FIG. 23 is a sectional view illustrating part of a section of a cartridge according to the third aspect of the modification of the first embodiment;

FIG. 24 is a perspective view illustrating closeup of a configuration near to a placing portion of the cartridge in the state that the circuit board 40 is detached according to the third aspect of the modification;

FIG. 25 is a perspective view illustrating the schematic configuration of a printer equipped with ink cartridges as an application of the liquid supply unit according to a second embodiment of the present disclosure;

FIG. 26 is an appearance perspective view illustrating a cartridge according to the second embodiment;

FIG. 27 is an appearance perspective view illustrating the cartridge in the state that the circuit board is detached;

FIG. 28 is a sectional view illustrating the configuration of a holder;

FIG. 29 is a sectional view illustrating the configuration of the cartridge and the holder in the mounted state;

FIG. 30 is a perspective view illustrating an ink cartridge as an application of the liquid supply unit according to a third embodiment of the present disclosure;

FIG. 31 is a side view illustrating the cartridge;

FIG. 32 is a bottom view illustrating the cartridge;

FIG. 33 is a perspective view illustrating the configuration of the carriage according to the third embodiment;

FIG. 34 is a perspective view illustrating the detailed configuration of a holder-side electrode assembly shown in FIG. 33;

FIG. 35 is a first sectional view illustrating sections of the cartridge and a holder in the process of mounting the cartridge;

FIG. 36 is a second sectional view illustrating the sections of the cartridge and the holder in the process of mounting the cartridge;

FIG. 37 is a third sectional view illustrating the sections of the cartridge and the holder in the process of mounting the cartridge;

FIG. 38 is a diagram illustrating the configuration of a circuit board according to a modification;

FIG. 39 is a sectional view illustrating closeup of a contact of a terminal and an outside electrode in the mounted state;

FIG. 40 is a diagram illustrating the configuration of a circuit board according to Modification 2;

FIG. 41 is a conceptual diagram illustrating a modification of the shape of the cartridge; and

FIG. 42 is a diagram illustrating the configuration of a liquid supply unit according to a modification.

### DESCRIPTION OF EMBODIMENTS

The following describes some embodiments of the present disclosure in a sequence given below:

### A. First Embodiment: Configuration of Mounting and Dismounting Ink Cartridge in Vertical Direction

A1. Configuration of Printer

A2. Configuration of Cartridge 20

A3. Detailed Configuration of Circuit Board 40

A4. Detailed Configuration of Carriage 60

A5. Modifications of First Embodiment

### B. Second Embodiment: Configuration of Mounting and Dismounting Ink Cartridge in Horizontal Direction

### C. Third Embodiment: Configuration of Rotationally Mounting and Dismounting Ink Cartridge

### D. Modifications of Respective Embodiments

### A. First Embodiment

A1. Configuration of Printer

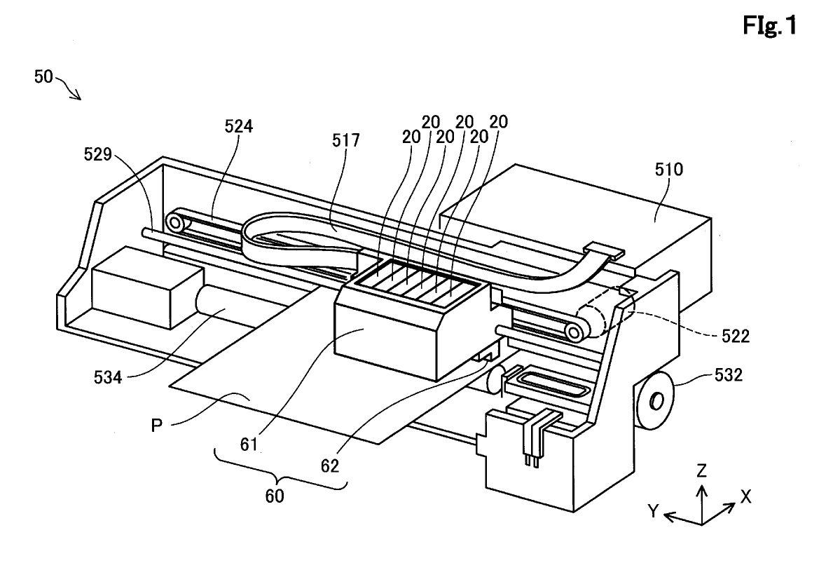

FIG. 1 is a perspective view illustrating the schematic configuration of a printer equipped with ink cartridges as an application of the liquid supply unit according to an embodiment of the present disclosure. FIG. 1 is a partly breakaway view to explicitly illustrate the internal configuration of a printer 50 in a use state. According to the embodiment, the use state means the state that the printer 50 ejects ink to perform printing. In FIG. 1, a Z axis is set parallel to a vertical direction in the use state. An X axis and a Y axis are set, such that an X-Y plane is parallel to a horizontal plane in the use state. A +Z direction indicates a vertically upward direction, and a −Z direction indicates a vertically downward direction. An X axis, a Y axis and a Z axis in subsequent drawings are set along the same directions as those of the X axis, the Y axis and the Z axis in FIG. 1.

According to the embodiment, the printer 50 is a small-size inkjet printer for personal use and is configured to perform printing by ejecting multiple different colors of inks. More specifically, the printer 50 is capable of ejecting a total of six different colors (six different types) of inks, black, yellow, magenta, light magenta, cyan and light cyan. The printer 50 may be configured to eject any number of different types of inks, instead of the six different types of inks. Ink is supplied to the printer 50 in the state that the user detachably mounts each ink cartridge 20 (hereinafter also called “cartridge 20”) configured to contain each color of ink as described later to the printer 50. The printer 50 is placed on a plane parallel to the horizontal plane, for example, a top face of a desk, in the use state

The printer 50 includes a carriage 60, a feed rod 529, a controller 510, a flexible cable 517, a drive belt 524, a carriage motor 522, a feed motor 532, a platen 534, and six cartridges 20.

The carriage 60 includes a holder 61 and a print head 62. According to the embodiment, the printer 50 is an on-carriage-type printer or more specifically has the cartridges 20 that are mounted on the carriage 60 reciprocating in a scanning direction. According to the embodiment, the scanning direction is a direction parallel to the Y axis. The holder 61 allows up to six cartridges 20 to be mounted thereto. Six cartridges 20 are mounted in FIG. 1. The holder 61 is configured to introduce ink from the cartridge 20 mounted thereto to the print head 62. The print head 62 has a large number of non-illustrated nozzles that are opened vertically downward in the use state and causes ink droplets to be ejected from these nozzles toward a printing medium P. According to the embodiment, the printing medium P is a sheet of printing paper. The printing medium P is, however, not limited to the printing paper but may be any medium, such as a label or cloth. The feed rod 529 has a long rod-like appearance shape and is placed parallel to the scanning direction. The feed rod 529 supports the carriage 60 to be movable along the scanning direction.

The controller 510 controls the respective parts of the printer 50. The controller 510 and the carriage 60 are electrically connected with each other by the flexible cable 517. The print head 62 ejects ink droplets in response to a control signal output from the controller 510, so as to create characters and images on the printing medium P. The controller 510 determines mounting or non-mounting of the cartridge 20 to the holder 61 and identifies the type of ink contained in the cartridge 20 mounted to the holder 61, based on signals received from the carriage 60 via the flexible cable 517.

The drive belt 524 is an endless belt and is arranged parallel to the scanning direction and parallel to the feed rod 529. The carriage 60 is mounted to the drive belt 524. The carriage motor 522 drives the drive belt 524. The carriage 60 reciprocates along the scanning direction by driving the drive belt 524.

The feed motor 532 rotates and drives the platen 534. The platen 534 has a columnar appearance shape and has its longitudinal direction (axial direction) that is arranged parallel to the scanning direction. The platen 534 is located vertically below the printing medium P to be in contact with the printing medium P. Rotating and driving the platen 534 feeds the printing medium P in a sub-scanning direction. The sub-scanning direction is a direction perpendicular to the main scanning direction and is a direction parallel to the X axis according to this embodiment. The carriage motor 522 described above and the feed motor 532 are controlled by the controller 510.

A2. Configuration of Cartridge 20

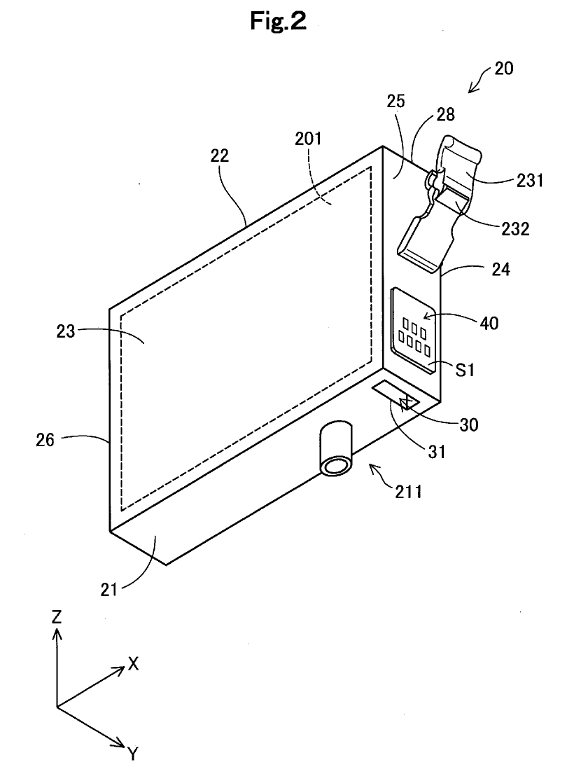

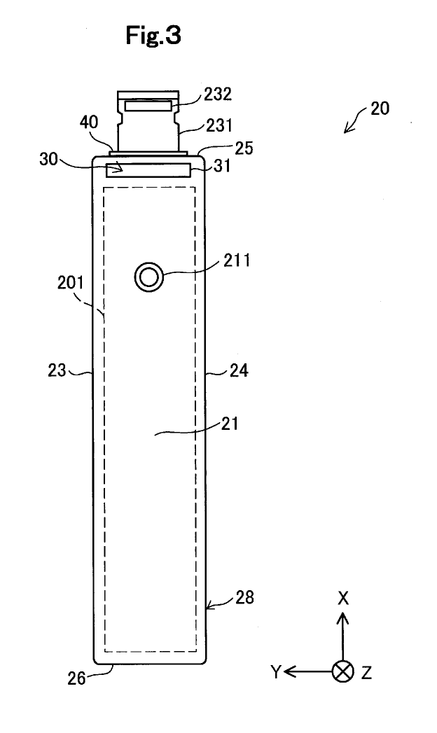

FIG. 2 is an appearance perspective view illustrating the cartridge 20. FIG. 3 is a bottom view illustrating the cartridge 20. In FIG. 2 and FIG. 3, an X axis, a Y axis and a Z axis are shown to clearly show the attitude of the cartridge 20 in the use state. The cartridge 20 is a semi-sealed type ink cartridge configured to intermittently introduce the outside air into a liquid container portion 201 with consumption of ink.

The cartridge 20 has an approximately rectangular parallelepiped appearance shape. The cartridge 20 includes an outer shell 28, a liquid container portion 201, a liquid supply portion 211, a lever 231 and a circuit board 40.

The outer shell 28 has six faces exposed outside or more specifically has a first face 21, a second face 22, a third face 23, a fourth face 24, a fifth face 25 and a sixth face 26. The first face 21 corresponds to a bottom face. The second face 22 corresponds to a top face and is opposed to the first face 21. The third face 23 to the sixth face 26 correspond to side faces. The third face 23 is arranged to intersect with the first face 21 and the second face 22. The term “intersect” is used in a broad sense including the arrangement that partial outer circumferences of respective faces are in contact with each other and the arrangement that virtual faces obtained by extending (stretching) respective faces to be parallel to the respective faces cross each other. The fourth face 24 is arranged to intersect with the first face 21 and the second face 22 and is opposed to the third face 23. The fifth face 25 is arranged to intersect with the first face 21, the second face 22, the third face 23 and the fourth face 24. The sixth face 26 is arranged to intersect with the first face 21, the second face 22, the third face 23 and the fourth face 24 and is opposed to the fifth face 25. The six faces 21 to 26 are formed to be approximately planar. The term “approximately planar” is used in a broad sense including the state that the entire face is perfectly flat and the state that the face partly has some concavity and convexity. Accordingly, even a face partly having some concavity and convexity is expressed as an approximately planar face as long as the face is recognizable as a face or a wall forming the outer shell 28 of the cartridge 20. All the first face 21 to the sixth face 26 have rectangular outer shapes in planar view. The outer shell 28 is made of a synthetic resin such as polypropylene (PP). Part of the outer shell 28 may be made of a resin film.

A placing portion 30 described later is formed in the outer shell 28. The placing portion 30 is formed as a bottomed hole that is extended vertically upward (in the +Z direction) from an opening 31 formed in the first face 21. An electrode assembly of the holder 61 described later is inserted in the placing portion 30 in the state that the cartridge 20 is mounted to the holder 61. The placing portion 30 (space) has an approximately rectangular parallelepiped shape.

The liquid container portion 201 is formed inside of the outer shell 28 as a chamber to contain ink therein. The liquid container portion 201 supplies ink to the liquid supply portion 211 via a non-illustrated ink supply path provided inside of the outer shell 28. The liquid container portion 201 is arranged to communicate with a non-illustrated air communication hole provided in the outer shell 28, such that the ambient air is introduced into the liquid container portion 201 with consumption of ink.

The liquid supply portion 211 has a tubular appearance shape protruded in the −Z direction from the first face 21, and an ink introducing needle 95 of the holder 61 described later is inserted into the liquid supply portion 211. The liquid supply portion 211 supplies the ink that is supplied from the liquid container portion 201, via the holder 61 to the print head 62. As shown in FIG. 2, the liquid supply portion 211 is placed on the first face 21 at a position nearer to the fifth face 25 than the sixth face 26.

The lever 231 has a thin plate-like appearance shape and is joined with the fifth face 25 to be protruded in the +X direction and in the +Z direction from the fifth face 25. The lever 231 has a convex portion 232 that is placed in its approximate center region and that is protruded in the +X direction. As described later, the convex portion 232 comes into contact with the holder 61 in the holder 61 in the state that the cartridge 20 is mounted to the holder 61 (hereinafter called “mounted state”), in order to suppress the cartridge 20 from unintentionally coming off from the holder 61 and suppress a positional misalignment of the cartridge 20 in the holder 61. In the process of dismounting the cartridge 20 from the holder 61, the user operates the lever 231 to be close to the fifth face 25 and thereby release the contact of the lever 231 with the holder 61.

The circuit board 40 is a thin plate-like member with a plurality of terminals arranged on a surface and a rear face and is placed on the lower side of the fifth face 25 to form part of the fifth face 25. As shown in FIG. 3, the circuit board 40 is located between the liquid supply portion 211 and the lever 231 in the +Z direction and in the −X direction. As shown in FIG. 2 and FIG. 3, seven terminals are placed on a face of the circuit board 40 exposed outside (face corresponding to a +X direction end face, hereinafter called “surface S1”). Although not being illustrated in FIG. 2, two terminals are placed on a face opposite to the surface S1 (face corresponding to a −X direction end face, hereinafter called “rear face S2”). The detailed configuration of the circuit board 40 and the terminals will be described later.

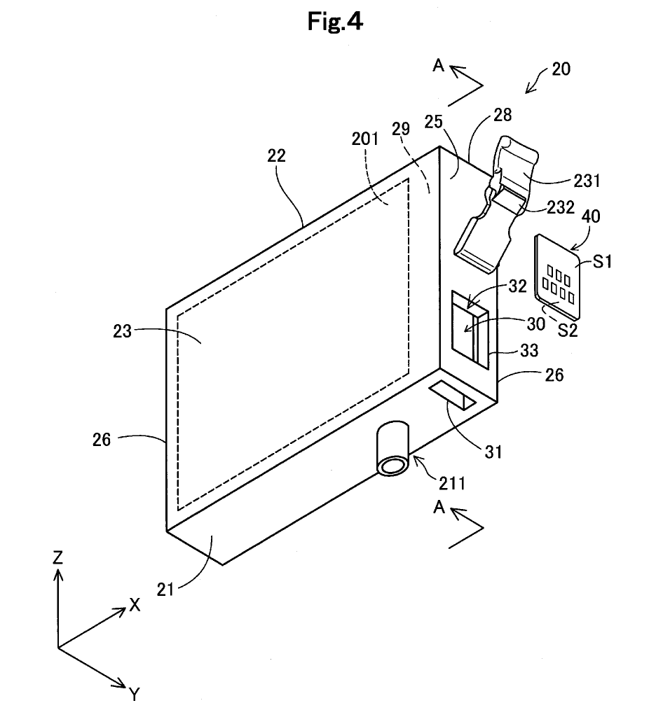

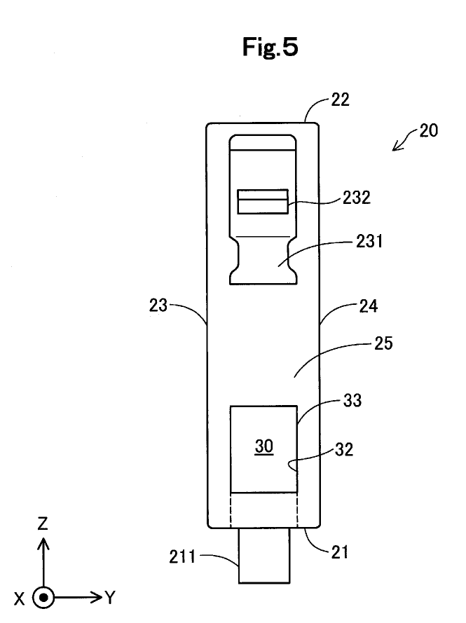

FIG. 4 is an appearance perspective view illustrating the cartridge 20 in the state that the circuit board 40 is detached. FIG. 5 is a side view illustrating the cartridge 20 in the state that the circuit board 40 is detached. FIG. 5 illustrates a side view of the cartridge 20 when being viewed in a direction from the fifth face 25 toward the sixth face 26 (in the −X direction).

As shown in FIG. 4, the placing portion 30 is formed at a position on the lower side of the outer shell 28 and nearer to the fifth face 25. A through hole 32 pierced in the thickness direction is formed at a position nearer to the first face 21 in a +X direction wall 29 that forms part of the outer shell 28. Accordingly, an opening 33 is provided in the fifth face 25 as one end of the through hole 32. The circuit board 40 is placed on the fifth face 25 to close the opening 33. This configuration makes the non-illustrated terminals placed on the rear face S2 of the circuit board 40, accessible from the placing portion 30.

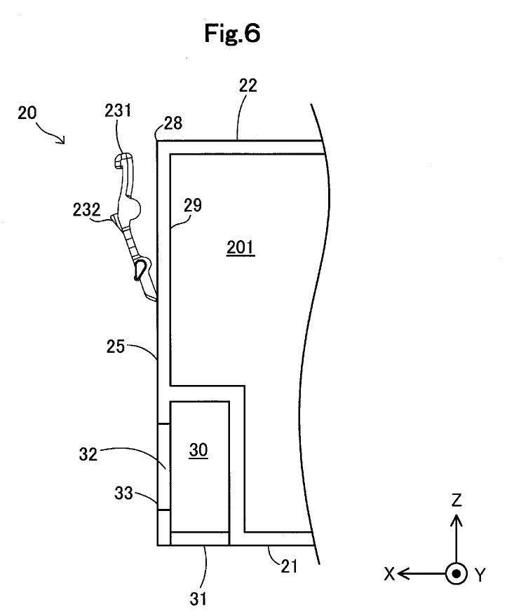

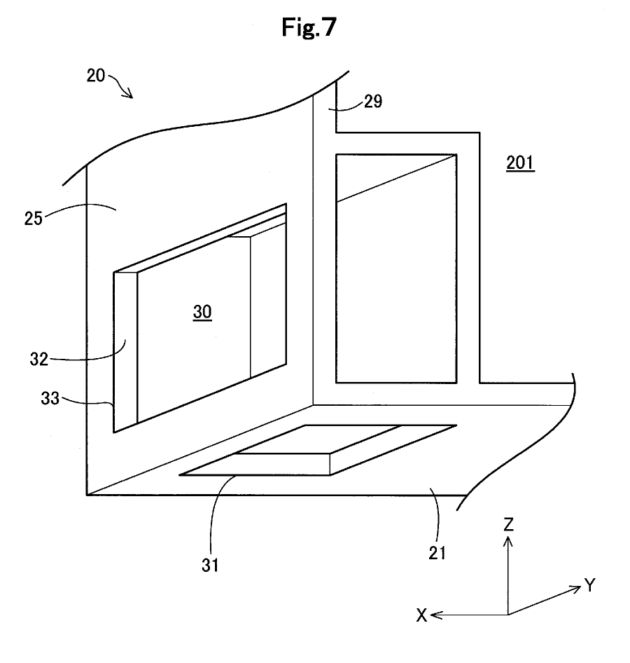

FIG. 6 is a sectional diagram illustrating an A-A section of the cartridge 20 shown in FIG. 4. FIG. 7 is a perspective view illustrating closeup of the configuration in the periphery of the placing portion 30 of the cartridge 20 in the state that the circuit board 40 is detached. FIG. 7 illustrates the cartridge 20 in a see-through manner with omission of a +Y direction wall of the outer shell 28 (wall of the fourth face 24).

As shown in FIG. 6, the placing portion 30 is located at a +X direction end and a −Z direction end in the outer shell 28 of the cartridge 20. As shown in FIG. 6 and FIG. 7, the placing portion 30 is accessible from the opening 31 provided in the first face 21. The rear face S2 of the circuit board 40 placed to close the opening 33 is accessible through the through hole 32 from the placing portion 30, although being omitted from the illustrations of FIG. 6 and FIG. 7.

A3. Detailed Configuration of Circuit Board 40

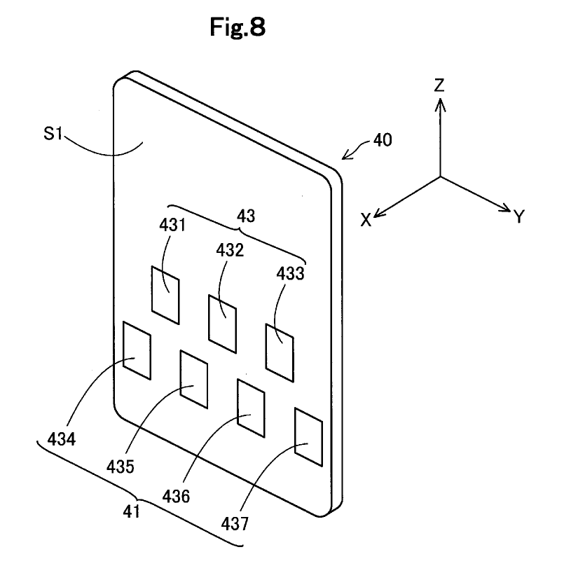

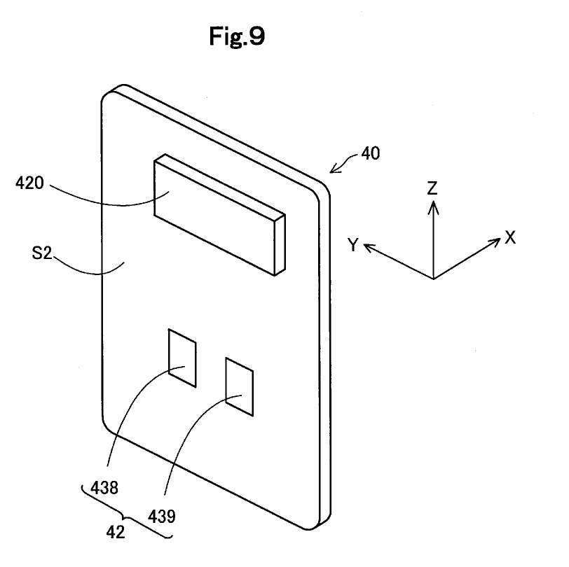

FIG. 8 is a perspective view illustrating the detailed configuration of the surface S1 of the circuit board 40. FIG. 9 is a perspective view illustrating the detailed configuration of the rear face S2 of the circuit board 40. The X axis, the Y axis and the Z axis are shown in FIG. 8 and FIG. 9, in order to clearly show the attitude of the circuit board 40 in the use state.

As shown in FIG. 8, seven terminals (a first terminal 431, a second terminal 432, a third terminal 433, a fourth terminal 434, a fifth terminal 435, a sixth terminal 436 and a seventh terminal 437) are placed on the surface S1 of the circuit board 40. The three terminals 431 to 433 are aligned parallel to the Y-axis direction to form a third terminal array 43. The remaining four terminals 434 to 437 are aligned at predetermined intervals parallel to the Y-axis direction to form a first terminal array 41. According to the embodiment, the third terminal array 43 is located above (on the +Z direction of) the first terminal array 41.

As shown in FIG. 9, two terminals (an eighth terminal 438 and a ninth terminal 439) and a storage unit 420 are placed on the rear face S2 of the circuit board 40. The two terminals 438 and 439 are aligned parallel to the Y-axis direction to form a second terminal array 42. The storage unit 420 is placed on the upper side and the second terminal array 42 is placed on the lower side of the rear face S2. The storage unit 420 stores information regarding ink contained in the cartridge 20, for example, information on the type of ink and the remaining amount of ink.

All the respective terminals 431 to 439 have rectangular shapes in planar view and are made of an electrically conductive material. According to the embodiment, the respective terminals 431 to 439 are formed to have approximately planar surfaces. According to the embodiment, the electrically conductive material used is a material of copper (Cu) plated with gold (Au). In the mounted state, the respective terminals 431 to 439 come into contact with electrodes provided in the holder 61 described later. The contact of the respective terminals 431 to 439 with the holder 61 will be described later.

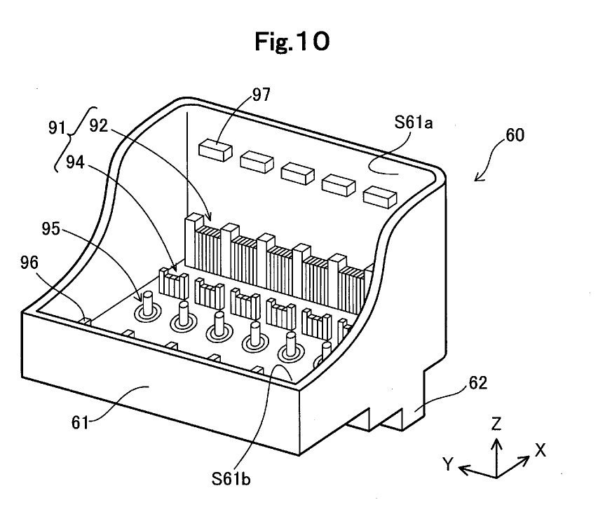

Both the first terminal 431 and the third terminal 433 serve as terminals for detecting a short circuit and as terminals for detecting mounting and dismounting of the cartridge 20. The first terminal 431 and the third terminal 433 are electrically connected with each other inside of the circuit board 40. Such electrical connection may be implemented, for example, by an electrically conductive path formed by a non-illustrated electrically conductive pattern formed on the surface and inside of the circuit board 40 and a bonding wire arranged to connect the electrically conductive pattern with a non-illustrated terminal of the storage unit 420. The seventh terminal 437 is a terminal used to transmit a high-voltage signal, for example, a signal identifying mounting or non-mounting of the cartridge 20 with regard to each slot. Six slots (mounting spaces) are provided in the holder 61 along the Y-axis direction (as shown in FIG. 10), and its details will be described later. Identifying mounting or non-mounting of the cartridge 20 with regard to each slot means determining whether any cartridge 20 comes off from any slot among these six slots.

All the second terminal 432, the fifth terminal 435, the sixth terminal 436, the eighth terminal 438 and the ninth terminal 439 are electrically connected with the storage unit 420 and are used, for example, to control the operations of the storage unit 420, to read data from the storage unit 420 and to write data into the storage unit 420. More specifically, the second terminal 432 is used to supply a reset signal to the storage unit 420. The fifth terminal 435 is used to input data into the storage unit 420 and output data from the storage unit 420. The sixth terminal 436 is used to supply a clock signal to the storage unit 420. The eighth terminal 438 serves as a terminal for supplying a DC power source to the storage unit 420. The ninth terminal 439 serves as a terminal for grounding (terminal used to receive a supply of 0V that is a ground voltage). The fourth terminal 434 is a terminal used to transmit a high-voltage signal, like the seventh terminal 437. The voltages of the signals input into the fourth terminal 434 and the seventh terminal 437 are approximately 40 V. The voltage of the signals input into the terminals other than these two terminals 434 and 437 and the ninth terminal 439 are approximately 3.3 V.

As described above, in the circuit board 40 of the embodiment, the terminal groups are placed in a dispersive manner on the surface S1 and on the rear face S2. This configuration allows for expansion in size of each terminal, compared with a configuration that all terminals are placed on one face. The surface S1 has only terminals for signals and does not have any terminal for power line having a lower impedance. This configuration reduces the adverse effect, for example, a short circuit caused by a foreign substance from outside.

A4. Detailed Configuration of Carriage 60

FIG. 10 is a perspective view illustrating the detailed configuration of the carriage 60. The holder 61 has a top-opened box-like appearance shape and includes a +X direction wall face S61a and a −Z direction bottom face S61b arranged perpendicular to the wall face S61a. As shown in FIG. 1, the six cartridges 20 are aligned in the Y-axis direction and are placed in the holder 61. In other words, the six cartridges 20 are mounted to the holder 61, such that the third face 23 of one cartridge 20 out of two adjacent cartridges 20 is opposed to the fourth face 24 of the other cartridge 20. In order to allow for such mounting of the cartridges 20, six slots (mounting spaces) are provided along the Y-axis direction in the holder 61. As shown in FIG. 10, each slot includes a holder-side electrode assembly 91, an ink introducing needle 95, a partition wall 96 and a projection 97.

The holder-side electrode assembly 91 includes an outside electrode holder 92 and an inside electrode holder 94. The outside electrode holder 92 has a thin plate-like appearance shape and is arranged to stand upward from a bottom face inside of the holder 61 at a position near to the wall face S61a. Seven electrodes described later are placed in the outside electrode holder 92, and parts of these seven electrodes are exposed on the −X direction side. The inside electrode holder 94 has a thin plate-like appearance shape and is placed away from the outside electrode holder 92 by a predetermined distance in the −X direction. Like the outside electrode holder 92, the inside electrode holder 94 is arranged to stand upward from the bottom face inside of the holder 61. Two electrodes described later are placed in the inside electrode holder 94, and parts of these two electrodes are exposed on the +X direction side.

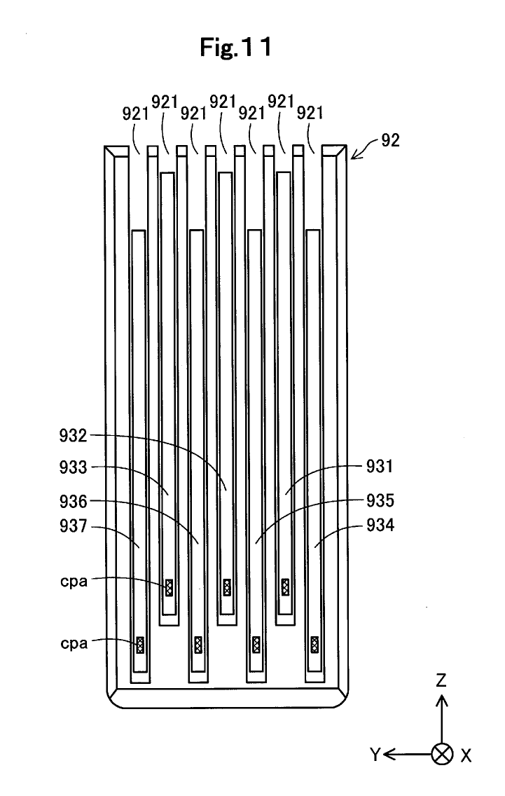

FIG. 11 is a front view illustrating the detailed configuration of the outside electrode holder 92. The outside electrode holder 92 is configured such that seven outside electrodes 931, 932, 933, 934, 935, 936 and 937 are fit in seven slits 921 extended in a direction parallel to the Z-axis direction. A lower part of each of the outside electrodes 931 to 937 is bent to be protruded in the −X direction, although not being illustrated. A portion protruded most in the −X direction of the bent part serves as a contact cpa that comes into contact with a predetermined terminal of the circuit board 40. In the description below, the bent part including the contact cpa in each of the outside electrodes 931 to 937 may simply be called “bent portion”. The contact cpa of the outside electrode 931 comes into contact with the first terminal 431 of the circuit board 40 in the mounted state. Similarly, in the mounted state, the contact cpa of the outside electrode 932 comes into contact with the second terminal 432, the contact cpa of the outside electrode 933 comes into contact with the third terminal 433, the contact cpa of the outside electrode 934 comes into contact with the fourth terminal 434, the contact cpa of the outside electrode 935 comes into contact with the fifth terminal 435, the contact cpa of the outside electrode 936 comes into contact with the sixth terminal 436, and the contact cpa of the outside electrode 937 comes into contact with the seventh terminal 437. Accordingly, the three contacts cpa of the three outside electrodes 931 to 933 are aligned parallel to the Y axis. The four contacts cpa of the remaining four outside electrodes 934 to 937 are aligned parallel to the Y axis. In the description below, the four outside electrodes 934 to 937 that are arranged to come into contact with the first terminal array 41 and respectively have the contact cpa may be collectively called first electrodes 930a. The three outside electrodes 931 to 933 that are arranged to come into contact with the third terminal array 43 and respectively have the contact cpa may be collectively called third electrodes 930c.

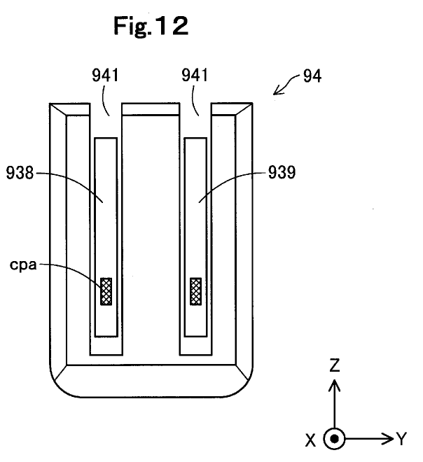

FIG. 12 is a front view illustrating the detailed configuration of the inside electrode holder 94. The inside electrode holder 94 is configured such that two inside electrodes 938 and 939 are fit in two slits 941 extended in a direction parallel to the Z axis. A lower part of each of the inside electrodes 938 and 939 is bent to be protruded in the +X direction. A portion protruded most in the +X direction of the bent part serves as a contact cpa that comes into contact with a predetermined terminal of the circuit board 40. In the description below, the bent part including the contact cpa in each of the inside electrodes 938 and 939 may simply be called “bent portion”.

In the mounted state, the inside electrode holder 94 is placed in the placing portion 30 and comes into contact with the two terminals 438 and 439 placed on the rear face S2 of the circuit board 40. More specifically, the contact cpa of the inside electrode 938 comes into contact with the eighth terminal 438 in the mounted state. The contact cpa of the inside electrode 939 comes into contact with the ninth terminal 439 in the mounted state. Accordingly, the two contacts cpa of the two inside electrodes 938 and 939 are aligned parallel to the Y axis. In the description below, the two inside electrodes 938 and 939 may be collectively called second electrodes 930b. According to the embodiment, the width in planar view (length in the direction parallel to the Y-axis direction) of the inside electrode holder 94 is smaller than the width in planar view of the outside electrode holder 92.

All the first electrodes 930a, the second electrodes 930b and the third electrodes 930c are configured by bending thin metal wire rods. This bent portion has elasticity (spring property) and can be warped in a protruding direction of the bent portion and in its opposite direction. The details of such warp of the first to the third electrodes 930a to 930c will be described later.

As shown in FIG. 10, the ink introducing needle 95 has a tubular appearance shape and is arranged to stand upward from the bottom face S61b inside of the holder 61. The ink introducing needle 95 has a tapered leading end (+Z direction end), although not being illustrated. The ink introducing needle 95 is inserted into the liquid supply portion 211 of the cartridge 20 in the mounted state. The ink introducing needle 95 communicates with a non-illustrated ink supply path provided in the bottom of the holder 61 to supply ink through the ink supply path to the print head 62.

The projection 97 is configured as a protrusion that is protruded in the −X direction in an upper portion of a +X direction wall portion of the holder 61. In the mounted state, the projection 97 comes into contact with the convex portion 232 of the lever 231 of the cartridge 20 to suppress a positional misalignment of the cartridge 20 and to suppress the cartridge 20 from coming off from the slot.

The cartridge 20 is moved vertically downward (moved down) to be placed in (mounted to) each slot of the holder 61 having the above configuration. In this state, the cartridge 20 is positioned such that its own liquid supply portion 211 receives the ink introducing needle 95 inserted therein. In the insertion completed state, the convex portion 232 of the lever 231 comes into contact with a predetermined part of the projection 97.

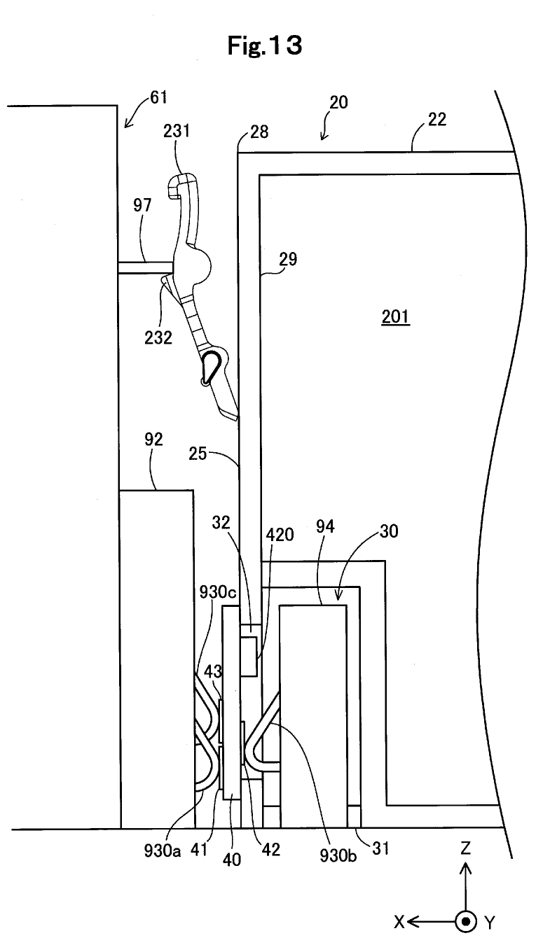

FIG. 13 is a sectional view illustrating the configuration of the cartridge 20 and the holder 61 in the mounted state. FIG. 13 illustrates a section at a similar position to that of the section shown in FIG. 6. FIG. 13 illustrates closeup of the configuration near to the holder-side electrode assembly 91 with omission of part of the configuration of the −X direction side of the cartridge 20 and part of the configuration of the +X direction side and the −Y direction side of the holder 61.

As shown in FIG. 13, in the mounted state, the storage unit 420 and the second terminal array 42 of the circuit board 40 are placed in the through hole 32. The inside electrode holder 94 is placed in the placing portion 30. Leading ends (+X direction ends) of the bent portions of the second electrodes 930b are placed in the through hole 32 to abut on the second terminal array 42 of the circuit board 40. The first electrodes 930a abut on the first terminal array 41, and the third electrodes 930c abut on the third terminal array 43.

An upper end of the convex portion 232 of the lever 231 comes into contact with a −X direction end of a lower face of the projection 97. In this state, an upward motion of the cartridge 20 causes the convex portion 232 to hit against the projection 97. This configuration accordingly suppresses such a motion and thereby suppresses the cartridge 20 from coming off from the holder 61. This configuration also enhances the position accuracy of the respective terminals 431 to 439. In the process of dismounting the cartridge 20 from the holder 61, the user moves an upper end of the lever 231 in a direction closer to the outer shell 28 (i.e., in the −X direction), so as to separate the convex portion 232 from the projection 97. In this state, the user lifts up the cartridge 20 vertically upward (in the +Y direction), so as to dismount the cartridge 20 from the holder 61.

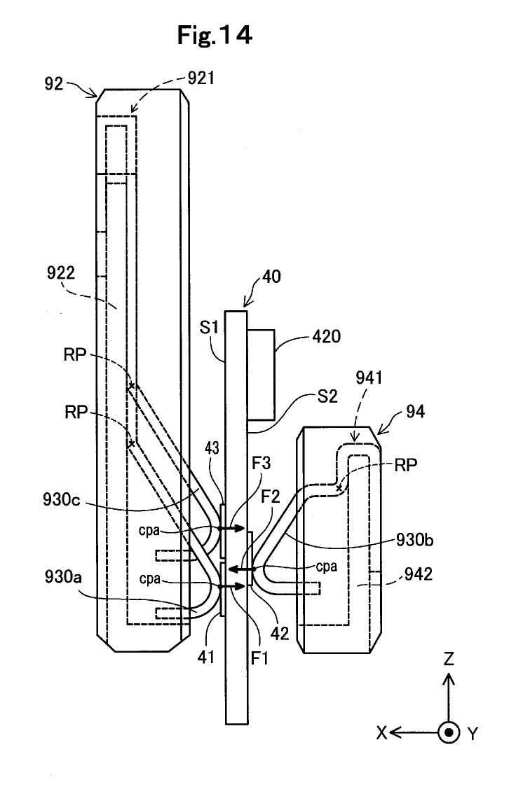

FIG. 14 is a diagram illustrating the detailed configuration of the circuit board 40, the outside electrode holder 92 and the inside electrode holder 94 in the mounted state. The outer shell 28 of the cartridge 20 and a lower part of the holder 61 are omitted from the illustration of FIG. 14. As shown in FIG. 14, the first electrode 930a is bent at a plurality of positions to be placed in a slit 921 of the outside electrode holder 92 and has a bent portion that is exposed in the −X direction from the surface of the main body. A support base 922 is provided in each slit 921 of the outside electrode holder 92, and the first electrode 930a is placed to be bent along the support base 922. The bent portion of the first electrode 930a is protruded in the −X direction from a bent point RP as a base point to be placed away from the support base 922. This bent portion is accordingly not supported by the support base 922 and can thus be warped in the −X direction or in the +X direction. Like the first electrode 930a, the third electrode 930c also has a bent portion that is protruded in the −X direction from a bent point RP as a base point and that can be warped in the −X direction or in the +X direction. The bent portions of the first electrode 930a and of the third electrode 930c are located at positions on the −X direction side (i.e., the direction side away from the support base 922) in the state that the cartridge 20 is not mounted to the holder 61, compared with the positions in the mounted state shown in FIG. 14.

The second electrode 930b is bent at a plurality of positions to be placed in a slit 941 of the inside electrode holder 94 and has a bent portion that is exposed from the surface of the main body. A support base 942 is provided in each slit 941 of the inside electrode holder 94, and the second electrode 930b is placed to be bent along the support base 942. The bent portion of the second electrode 930b is protruded in the +X direction from a bent point RP as a base point to be placed away from the support base 942. This bent portion is accordingly not supported by the support base 942 and can thus be warped in the +X direction or in the −X direction. The bent portion of the second electrode 930b is located at a position on the +X direction side (i.e., the direction side away from the support base 942) in the state that the cartridge 20 is not mounted to the holder 61, compared with the position in the mounted state shown in FIG. 14.

In the process of mounting the cartridge 20 to the holder 61, the circuit board 40 is inserted downward (in the −Z direction) between the outside electrode holder 92 and the inside electrode holder 94. As described above, the bent portions of the first to the third electrodes 930a to 930c have elasticity. The bent portions of the first to the third electrodes 930a to 930c are respectively warped in the direction toward the support base 922 or in the direction toward the support base 942 in the course of insertion of the circuit board 40, so as not to interfere with insertion of the circuit board 40. In the mounted state shown in FIG. 14, the contacts cpa of the first electrodes 930a are in contact with the first terminal array 41. In this state, the bent portions of the first electrodes 930a are to be returned in the +X direction, so that a force F1 in the −X direction is applied to the first terminal array 41.

Similarly, in the mounted state, the contacts cpa of the third electrodes 930c are in contact with the third terminal array 43, and a force F3 in the −X direction is applied to the third terminal array 43 by the third electrodes 930c. Similarly, in the mounted state, the contacts cpa of the second electrodes 930b are in contact with the second terminal array 42, and a force F2 in the +X direction is applied to the second terminal array 42 by the second electrodes 930b. As described above, forces are applied in the directions orthogonal to the respective terminals to the first terminal array 41, the second terminal array 42 and the third terminal array 43. This enhances the stability of electrical connection between the respective terminal arrays 41 to 43 and the respective electrodes 930a to 930c.

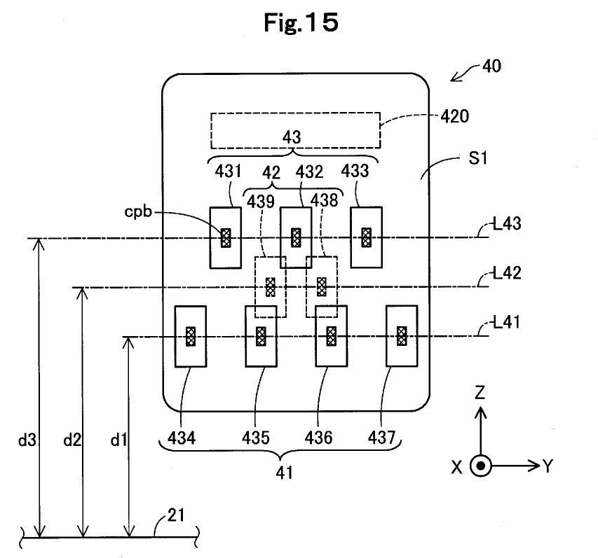

FIG. 15 is a diagram schematically illustrating the contact state of the circuit board 40 with the holder-side electrode assembly 91 in the mounted state. FIG. 15 illustrates the circuit board 40 such that the surface S1 of the circuit board 40 faces the front side. FIG. 15 illustrates a rear face S2-side configuration by broken lines.

As shown in FIG. 15, a contact portion cpb of each terminal that comes into contact with a corresponding contact cpa is located at the approximate center of each terminal. Accordingly, four contact portions cpb of the first terminal array 41 are located on a virtual straight line L41. Similarly, two contact portions cpb of the second terminal array 42 are located on a virtual straight line L42. Similarly, three contact portions cpb of the third terminal array 43 are located on a virtual straight line L43. These three virtual straight lines L41 to L43 are parallel to each other (parallel to the Y-axis direction) and do not overlap each other.

As shown in FIG. 15, with regard to distances between the first face 21 and the respective virtual straight lines L41 to L43, the smallest distance is a distance d1 between the first face 21 and the virtual straight line L41, the second smallest distance is a distance d2 between the first face 21 and the virtual straight line L42, and the largest distance is a distance d3 between the first face 21 and the virtual straight line L43. This relationship is attributed to the relationship on the distance between the respective terminal arrays 41 to 43 and the first face 21 that the smallest distance is a distance between the first terminal array 41 and the first face 21, the second smallest distance is a distance between the second terminal array 42 and the first face 21, and the largest distance is a distance between the third terminal array 43 and the first face 21. Based on this relationship on the distance, as shown in FIG. 13 and FIG. 14, the terminals 431 to 439 of the circuit board 40 are arranged in the sequence of the first terminal array 41, the second terminal array 42 and the third terminal array 43 along the direction from the first face 21 toward the second face 22. Accordingly, the forces F1 and F3 in the −X direction from the outside electrode holder 92 and the force F2 in the +X direction from the inside electrode holder 94 are applied to the circuit board 40 in a balanced manner. This configuration suppresses a positional misalignment of the circuit board 40 and the occurrence of distortion by these forces F1 to F3.

In the cartridge 20 of the first embodiment described above, the first terminal array 41 and the third terminal array 43 are arranged on the surface S1 of the circuit board 40, while the second terminal array 42 is separately arranged on the rear face S2 that is opposite to the surface S1. This configuration allows for expansion in size (area) of each terminal, compared with a configuration that these three terminal arrays 41 to 43 are all placed on one single face, i.e., on the surface S1 or on the rear face S2. Even in the event of a positional misalignment of the cartridge 20 relative to the printer 50 (holder 61), this configuration suppresses reduction of the stability of electrical connection between the cartridge 20 and the printer 50 (holder 61). Additionally, the separate arrangement of the first terminal array 41 and the third terminal array 43 on the surface S1 and the second terminal array 42 on the rear face S2 opposite to the surface S1 suppresses ink ejected from the print head 62 from adhering to both the first terminal array 41 and the second terminal array 42 to cause a short circuit between these two terminal arrays and suppresses the ink from adhering to both the third terminal array 43 and the second terminal array 42 to cause a short circuit between these two terminal arrays. This configuration accordingly suppresses reduction of the stability of electrical connection between the printer 50 and the cartridge 20.

The inside electrodes 938 and 939 of the inside electrode holder 94 are located inside of the placing portion 30 in the mounted state. In other words, the inside electrodes 938 and 939 are located between the liquid container portion 201 and the circuit board 40 in the mounted state. This configuration suppresses ink or any foreign substance such as dust from adhering to the inside electrodes 938 and 939 and also suppresses ink or any foreign substance from adhering to the second terminal array 42 that is in contact with the inside electrodes 938 and 939.

When the cartridge 20 is viewed in the direction from the first face 21 toward the second face 22 (in the +Y direction), the three terminal arrays 41 to 43 are all located between the liquid supply portion 211 and the lever 231. This configuration further improves the position accuracy of the three terminal arrays 41 to 43 by utilizing the effect of improving the position accuracy by the lever 231 (convex portion 232), compared with a configuration that the three terminal arrays 41 to 43 are arranged in the direction away from the lever 231 (in the −X direction) relative to the liquid supply portion 211.

The outer shell 28 of the cartridge 20 includes the placing portion 30 that is open to the surface S1 and places the inside electrode holder 94 therein in the mounted state. This configuration enables the inside electrode holder 94 to be placed in the placing portion 30 and enables the second electrodes 930b to come into contact with the second terminal array 42, simultaneously with the operation of mounting the cartridge 20 to the printer 50 (holder 61). This configuration enables the cartridge 20 to be mounted more readily or in a shorter time period, compared with a configuration that these two operations are performed separately.

In the circuit board 40, the number of terminals (seven) placed on the surface S1 is larger than the number of terminals (two) placed on the rear face S2. A total force (force F1+force F3) applied from the first electrodes 930a and the third electrodes 930c to the surface S1 (the first terminal array 41 and the third terminal array 43) is thus greater than a total force (force F2) applied from the second electrodes 930b to the rear face S2 (the second terminal array 42). The direction of a total force (force F1+force F2+force F3) applied to the circuit board 40 is accordingly the direction from the first electrodes 930a and the third electrodes 930c toward the second electrodes 930b (the −X direction). This configuration suppresses the circuit board 40 from coming off from the fifth face 25 of the cartridge 20.

The second terminal array 42 placed on the rear face S2 of the circuit board 40 is comprised of the terminals used to supply the power source to the storage unit 420. A short circuit of these two terminals, for example, caused by ink or any foreign substance adhering thereto is likely to make an overcurrent flow in a non-illustrated power supply circuit and damage the power supply circuit. In the cartridge 20 of the first embodiment, however, the second terminal array 42 is placed to face the placing portion 30. This configuration suppresses ink or any foreign substance from adhering to the second terminal array 42 and thereby suppresses the power supply circuit from being damaged, compared with a configuration that the second terminal array 42 is placed to be exposed outside of the cartridge 20.

The distances between the respective terminal arrays 41 to 43 and the first face 21 are set such that the smallest distance is the distance d1 between the first terminal array 41 and the first face 21, the second smallest distance is the distance d2 between the second terminal array 42 and the first face 21, and the largest distance is the distance d3 between the third terminal array 43 and the first face 21. This configuration enables the force F1 applied from the first electrodes 930a with the force F3 applied from the third electrodes 930c and the force F2 applied from the second electrodes 930b to be applied to the circuit board 40 in a balanced manner in the vertical direction (direction along the Z axis) and suppresses a positional misalignment of the circuit board 40 by these forces F1 to F3.

Furthermore, the separate arrangement of the first terminal array 41 and the third terminal array 43 on the surface S1 and the second terminal array 42 on the rear face S2 opposite to the surface S1 allows for a configuration that decreases the size of each of the terminals 431 to 439 and increases the distance between the respective terminals, while keeping the areas of the surface S1 and the rear face S2 of the circuit board 40 unchanged. This configuration suppresses the occurrence of a short circuit between the respective terminals and improves the reliability of electrical connection. The separate arrangement also allows for a configuration that decreases the areas of the surface S1 and the rear face S2, while keeping the distance between the respective terminals unchanged. This configuration achieves downsizing of the circuit board 40 and contributes to downsizing of the cartridge 20.

The first electrodes 930a of the first embodiment correspond to the subordinate concept of the first electrode in the claims. The second electrodes 930b correspond to the subordinate concept of the second electrode in the claims, and the third electrodes 930c correspond to the subordinate concept of the third electrode in the claims. The printer 50 corresponds to the subordinate concept of the liquid ejection apparatus in the claims, and the cartridge 20 corresponds to the subordinate concept of the liquid supply unit in the claims. The contact portions cpb come into contact with the first electrodes 930a correspond to the subordinate concept of the first contact portion in the claims. The contact portions cpb come into contact with the second electrodes 930b correspond to the subordinate concept of the second contact portion in the claims. The contact portions cpb come into contact with the third electrodes 930c correspond to the subordinate concept of the third contact portion in the claims. The circuit board 40 corresponds to the subordinate concept of the wall portion in the claims, the lever 231 (convex portion 232) corresponds to the subordinate concept of the restricting portion in the claims, and the outer shell 28 corresponds to the subordinate concept of the case in the claims. The through hole 32 corresponds to the subordinate concept of the through hole in the claims, and the wall 29 corresponds to the subordinate concept of the wall in the claims. The surface S1 corresponds to the subordinate concept of the first wall face in the claims, and the rear face S2 corresponds to the subordinate concept of the second wall face in the claims.

A5. Modifications of First Embodiment

A5-1. First Aspect

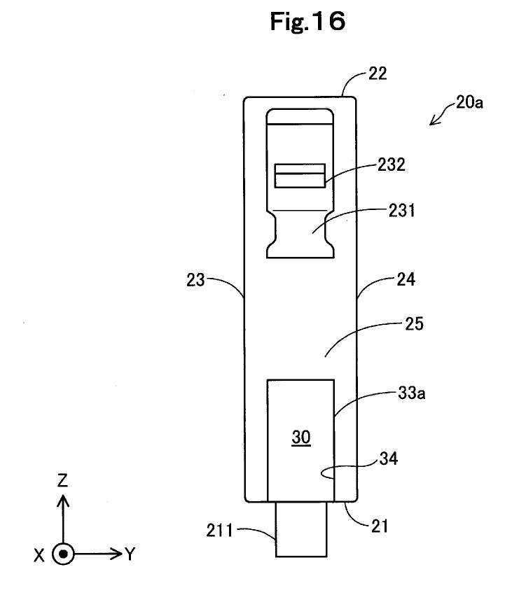

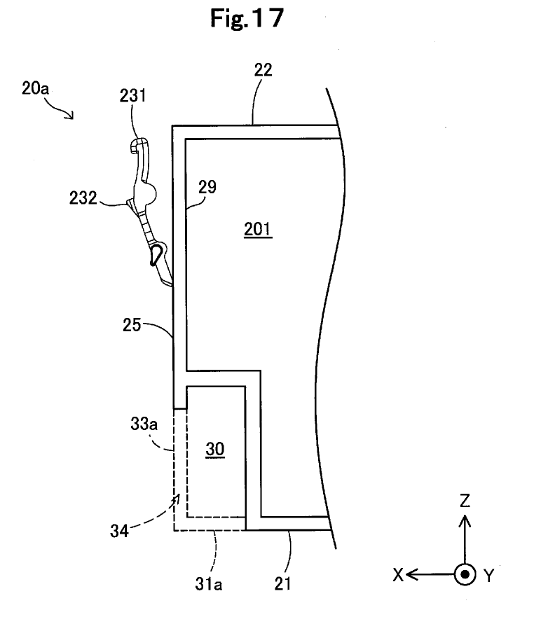

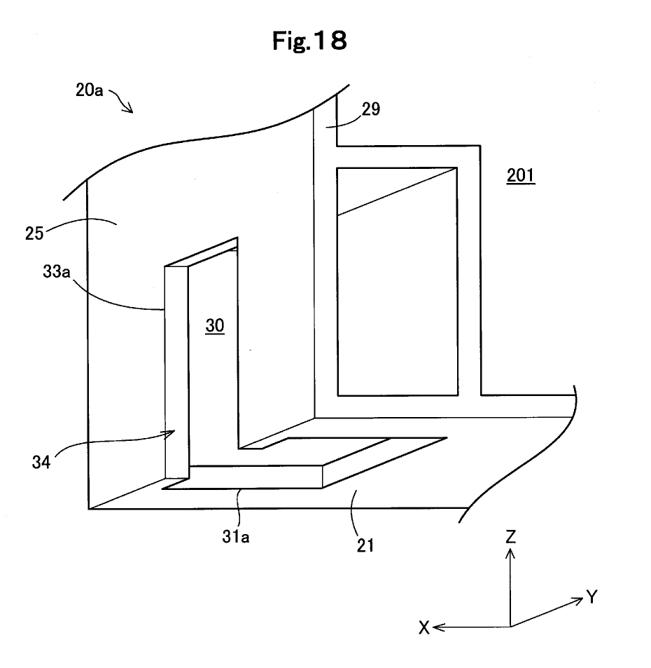

FIG. 16 is a side view illustrating a first aspect of the ink cartridge according to a modification of the first embodiment. Like FIG. 5, FIG. 16 illustrates a side face of a cartridge 20a in the state that the circuit board 40 is detached. FIG. 17 is a sectional view illustrating part of a section of the cartridge 20a according to the first aspect of the modification. FIG. 17 illustrates a section at a similar position to that of FIG. 6. FIG. 18 is a perspective view illustrating closeup of a configuration near to a placing portion 30 of the cartridge 20a in the state that the circuit board 40 is detached according to the first aspect of the modification.

The cartridge 20a according to the first aspect of the modification of the first embodiment differs from the cartridge 20 of the first embodiment by a cut 34 formed in place of the through hole 32. Otherwise the configuration of the cartridge 20a is similar to the configuration of the cartridge 20 of the first embodiment. Like components are expressed by like reference signs, and their detailed description is omitted.

As shown in FIGS. 16 to 18, an opening 33a is formed in the fifth face 25, in place of the opening 33. This opening 33a reaches a lower end of the fifth face 25, unlike the opening 33. An opening 31a is formed in the first face 21, in place of the opening 31. This opening 31a reaches a +X direction end, unlike the opening 31. The cut 34 is formed such that the opening 33a and the opening 31a are continuous with each other.

The cartridge 20a of the first aspect of the modification having the above configuration has similar advantageous effects to those of the cartridge 20 of the first embodiment. Additionally, the cartridge 20a includes the cut 34, and the wall 29 of the outer shell 28 is not present below the circuit board 40 in the state that the circuit board 40 is attached. This configuration suppresses the second electrodes 930b of the inside electrode holder 94 from rubbing against the wall to reach the second terminal array 42 in the process of mounting the cartridge 20a to the holder 61. This accordingly reduces the possibility of damage of the second electrodes 930b and the possibility of damage of the wall 29.

A5-2. Second Aspect

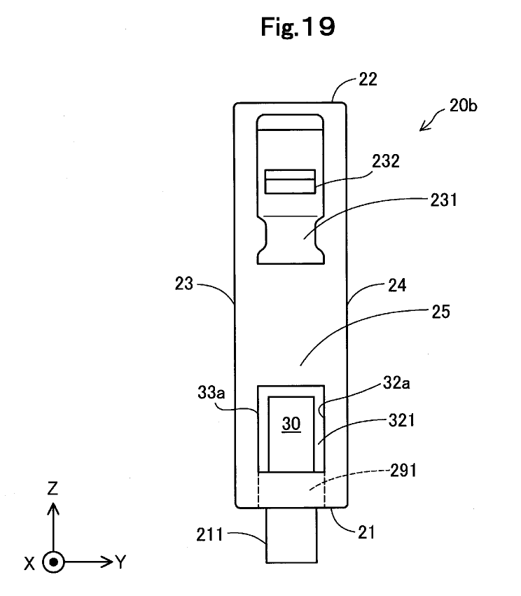

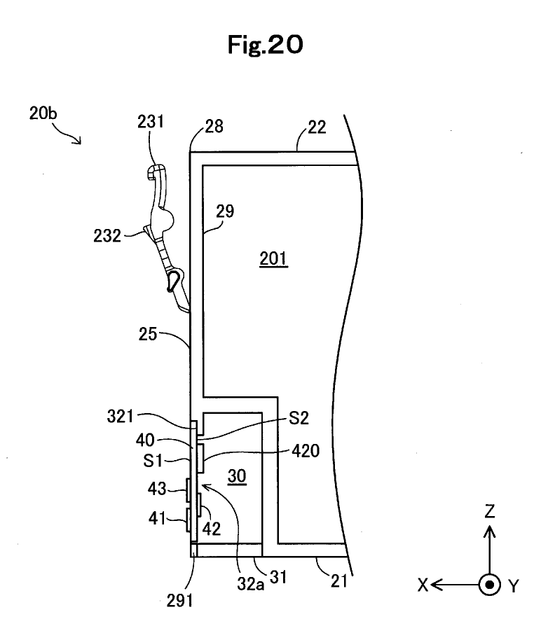

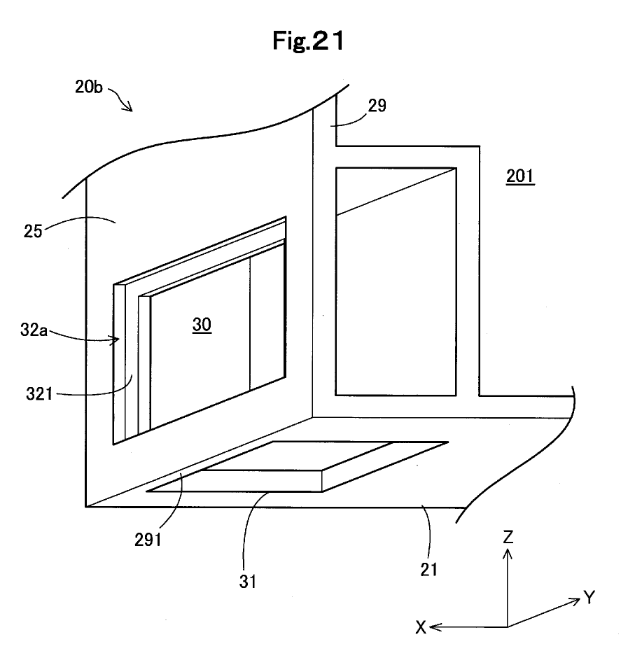

FIG. 19 is a side view illustrating a second aspect of the ink cartridge according to a modification of the first embodiment. Like FIG. 5, FIG. 19 illustrates a side face of a cartridge 20b in the state that the circuit board 40 is detached. FIG. 20 is a sectional view illustrating part of a section of the cartridge 20b according to the second aspect of the modification. FIG. 20 illustrates a section at a similar position to that of FIG. 6. FIG. 21 is a perspective view illustrating closeup of a configuration near to a placing portion 30 of the cartridge 20b in the state that the circuit board 40 is detached according to the second aspect of the modification of the first embodiment.

The cartridge 20b according to the second aspect of the modification of the first embodiment differs from the cartridge 20 of the first embodiment by a through hole 32a provided in place of the through hole 32. Otherwise the configuration of the cartridge 20b is similar to the configuration of the cartridge 20 of the first embodiment. Like components are expressed by like reference signs, and their detailed description is omitted.

The through hole 32a includes a step 321 provided in an approximate center portion in the depth direction (X-axis direction). The step 321 has a frame-like appearance shape that is protruded from an edge of an opening 33a toward the center of the opening when being viewed in the −Z direction. But step 321 is not protruded from a −Z direction edge. In other words, the through hole 32a has an appearance shape that is cut in its lower portion and that is folded back in an upper portion when being viewed in the −X direction. The opening 33a is larger than the opening 33 in the cartridge 20 of the first embodiment. More specifically, the opening 33a has a dimension that enables the circuit board 40 to be placed in the −X direction. The circuit board 40 is placed in the through hole 32a, such that a +Y direction edge, a +Z direction edge and a −Y direction edge of its outer circumference are in contact with a +X direction face of the step 321. The length from the +X direction face of the step 321 to the fifth face 25 is equal to the thickness (length in the X-axis direction) of the circuit board 40. Accordingly, as shown in FIG. 20, in the state that the circuit board 40 is placed in the through hole 32a, the position in the X-axis direction of the surface S1 of the circuit board 40 is flush with the position in the X-axis direction of the fifth face 25. Only the first terminal array 41 and the third terminal array 43 of the circuit board 40 are thus protruded in the +X direction relative to the fifth face 25.

As shown in FIG. 20, a portion of the wall 29 of the outer shell 28 that is located vertically below the circuit board 40 (hereinafter called “lower portion 291”) has a thickness (length in the X-axis direction) that is smaller than the thickness (length in the X-axis direction) of the remaining part of the wall 29. The lower portion 291 is formed to have a thickness that is equal to the thickness of the circuit board 40. Accordingly, as shown in FIG. 20, the position in the X-axis direction of an inner face (−X direction face) of the lower portion 291 is flush with the position in the X-axis direction of the rear face S2 of the circuit board 40.

The cartridge 20b of the second aspect of the modification having the above configuration has similar advantageous effects to those of the cartridge 20 of the first embodiment. Additionally, the position in the X-axis direction of the surface S1 of the circuit board 40 is flush with the position in the X-axis direction of the fifth face 25. The first electrodes 930a and the third electrodes 930c accordingly do not ride over the step corresponding to the thickness of the circuit board 40 to reach the first terminal array 41 and the third terminal array 43 in the process of mounting the cartridge 20b to the holder 61. This configuration accordingly suppresses the two terminal arrays 41 and 43 and the circuit board 40 from being damaged by the impact when the first electrodes 930a and the third electrodes 930c ride over the step. Similarly, the position in the X-axis direction of the rear face S2 of the circuit board 40 is flush with the position in the X-axis direction of the −X direction face of the lower portion 291. The second electrodes 930b accordingly do not ride over the step in the course of moving from the lower portion 291 to the circuit board 40, in the process of mounting the cartridge 20b to the holder 61. This configuration reduces the possibility of damage of the second electrodes 930a and the possibility of damage of the circuit board 40, compared with a configuration that causes the second electrodes 930a to ride over the step.

A5-3. Third Aspect

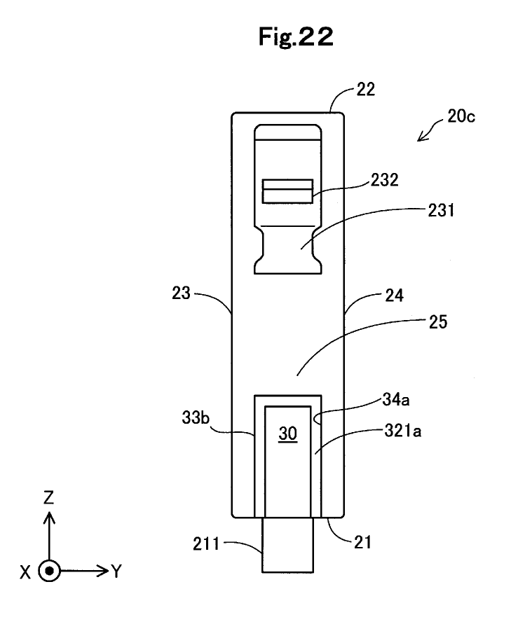

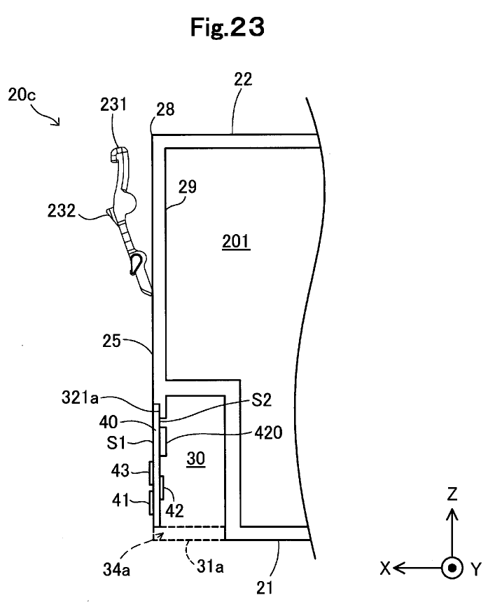

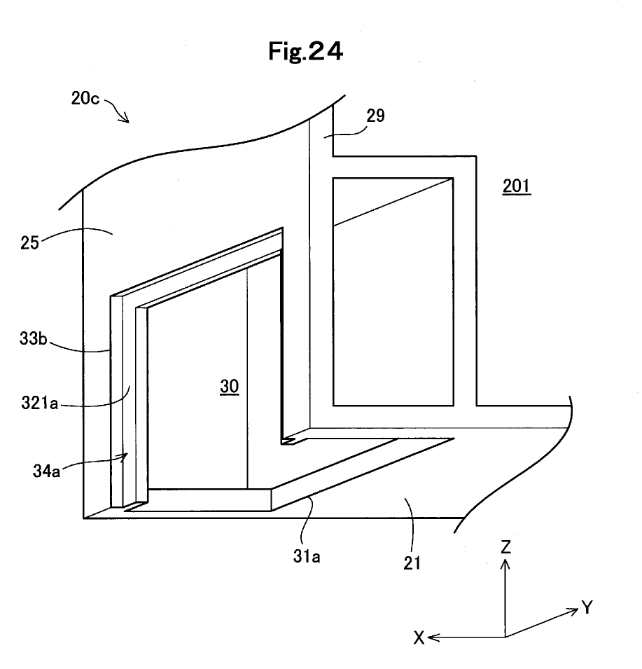

FIG. 22 is a side view illustrating a third aspect of the ink cartridge according to a modification of the first embodiment. Like FIG. 5, FIG. 22 illustrates a side face of a cartridge 20c in the state that the circuit board 40 is detached. FIG. 23 is a sectional view illustrating part of a section of the cartridge 20c according to the third aspect of the modification of the first embodiment. FIG. 23 illustrates a section at a similar position to that of FIG. 6. FIG. 24 is a perspective view illustrating closeup of a configuration near to a placing portion 30 of the cartridge 20c in the state that the circuit board 40 is detached according to the third aspect of the modification.

The cartridge 20c according to the third aspect of the modification of the first embodiment differs from the cartridge 20a of the first aspect of the modification of the first embodiment by a cut 34a provided in place of the cut 34. Otherwise the configuration of the cartridge 20c is similar to the configuration of the cartridge 20a of the first aspect of the modification. Like components are expressed by like reference signs, and their detailed description is omitted.

The cut 34a includes a step 321a. The step 321a differs from that of the cartridge 20b of the second aspect of the modification described above by both a +Y direction protruded portion and a −Y direction protruded portion of the step 321a reach a lower end of the fifth face 25. A +X direction opening 33b of the cut 34a (opening 33b formed in the fifth face 25) is larger than the opening 33a of the first aspect of the modification. More specifically, the opening 33b has a dimension that enables the circuit board 40 to be placed in the −X direction. The circuit board 40 is placed in the cut 34a, such that a +Y direction edge, a +Z direction edge and a −Y direction edge of its outer circumference are in contact with a +X direction face of the step 321a.

The cartridge 20c of the third aspect of the modification having the above configuration has similar advantageous effects to those of the cartridge 20a of the first aspect of the modification and also has similar advantageous effects to those of the cartridge 20b of the second aspect of the modification.

### B. Second Embodiment

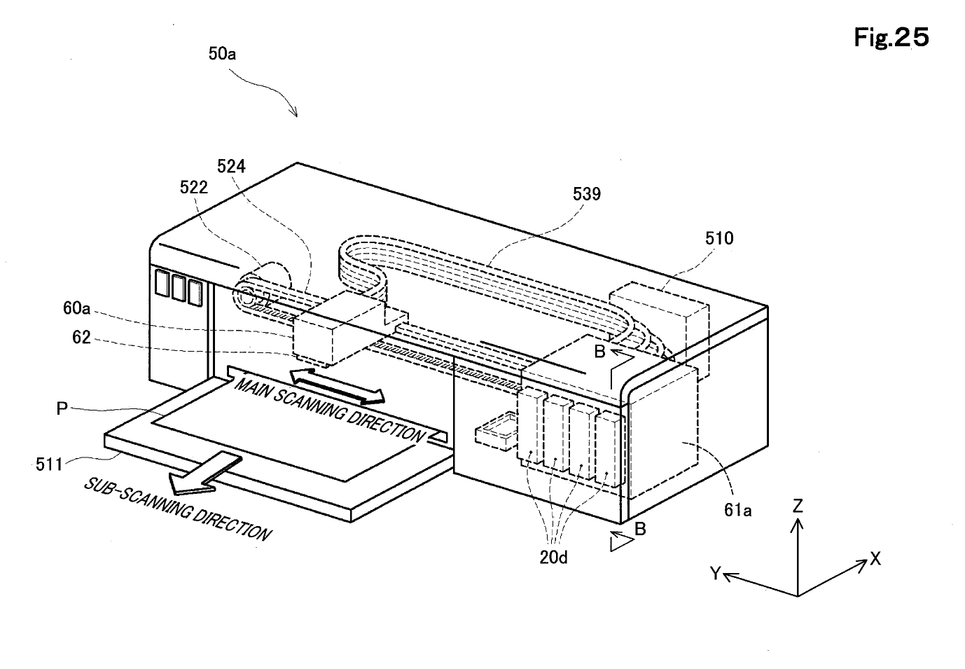

FIG. 25 is a perspective view illustrating the schematic configuration of a printer equipped with ink cartridges as an application of the liquid supply unit according to a second embodiment of the present disclosure. Like FIG. 1, FIG. 25 is a partly breakaway view to explicitly illustrate the internal configuration of a printer 50a.

The printer 50a of the second embodiment is an off-carriage type printer and differs from the printer 50 of the first embodiment shown in FIG. 1 by the presence of components to provide the off-carriage configuration, the specific configuration of a cartridge 20d, the mounting direction and the dismounting direction of the cartridge 20d that are the horizontal direction, and four different types of inks that are ejectable. Otherwise the configuration of the printer 50a is similar to the configuration of the printer 50. Like components are expressed by like reference signs, and their detailed description is omitted. Part of the components, for example, the feed rod 529 and the platen 534 shown in FIG. 1 are omitted from the illustration of FIG. 25.

The printer 50a includes a holder 61a, in place of the holder 61, as a component to provide the off-carriage configuration. The printer 50a also includes a head unit 60a, in place of the carriage 60. The head unit 60a differs from the carriage 60 of the first embodiment by that the head unit 60a is not provided with the holder 61 and is connected with tubes 539 described later. According to the second embodiment, the holder 61a is not mounted on the head unit 60a but is fixed to and placed in a housing of the printer 50a. The holder 61a and the head unit 60a are connected with each other by a plurality of tubes 539 that are provided for respective ink colors. Ink contained in the cartridge 20d is sucked by a non-illustrated pump mechanism provided in the printer 50a to be supplied to the head unit 60a. The holder 61a is configured to mount four cartridge 20d thereto.

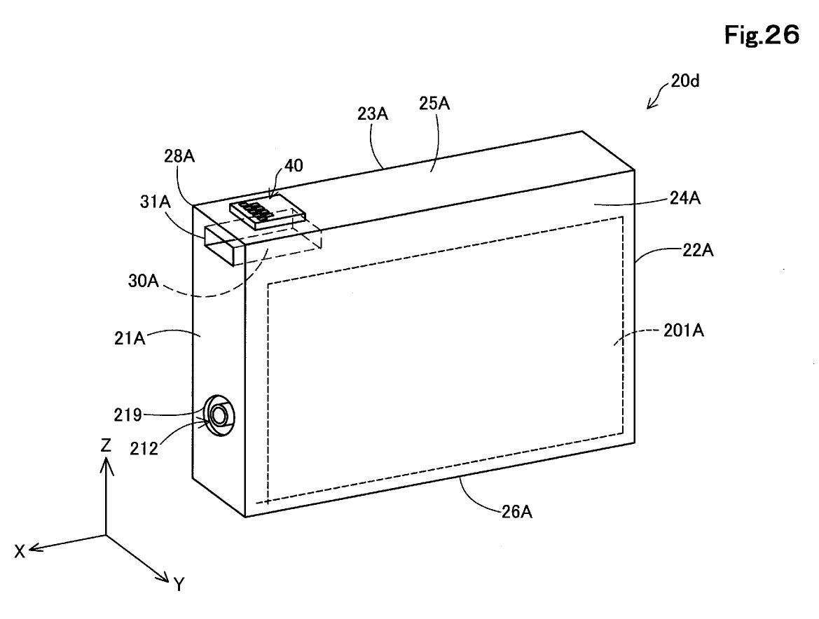

FIG. 26 is an appearance perspective view illustrating the cartridge 20d according to the second embodiment. In FIG. 26, the X axis, the Y axis and the Z axis are shown to clearly show the attitude of the cartridge 20d in the use state. The cartridge 20d is a semi-sealed type ink cartridge, like the ink cartridge 20 of the first embodiment.

The cartridge 20d has an approximately rectangular parallelepiped appearance shape. The cartridge 20d includes an outer shell 28A, a liquid container portion 201A, a liquid supply portion 212 and a circuit board 40. The circuit board 40 is similar to the circuit board 40 of the first embodiment, and its detailed description is omitted.

The outer shell 28A includes six faces exposed outside or more specifically has a first face 21A, a second face 22A, a third face 23A, a fourth face 24A, a fifth face 25A and a sixth face 26A. The positional relationship of the respective faces is similar to the positional relationship of the six faces 21 to 26 in the printer 50 of the first embodiment, and its detailed description is omitted.

The liquid container portion 201A is formed inside of the outer shell 28A to contain ink therein. The liquid supply portion 212 is a tubular member that is placed in a supply portion placing hole 219 and its back side, and an ink introducing needle 622 of the holder 61a described later is inserted into the liquid supply portion 212. The liquid supply portion 212 supplies ink that is supplied from the liquid container portion 201A, via the holder 61a and the tube 539 to the head unit 60a. The supply portion placing hole 219 is formed in the outer shell 28A to be pierced in the thickness direction. The liquid supply portion 212 is placed to have its own axis line that passes through the center of the supply portion placing hole 219 when being viewed in the −X direction.

The outer shell 28A includes a placing portion 30A that is formed at a position near to an intersection of the first face 21A and the fifth face 25A. The placing portion 30A has the same functions as those of the placing portion 30 in the cartridge 20 of the first embodiment. The placing portion 30A is formed as a bottomed hole that is extended in the horizontal direction (in the −X direction) from an opening 31A formed in the first face 21A. An electrode assembly 691 of the holder 61a described later is inserted into the placing portion 30A in the state that the cartridge 20d is inserted into the holder 61a.

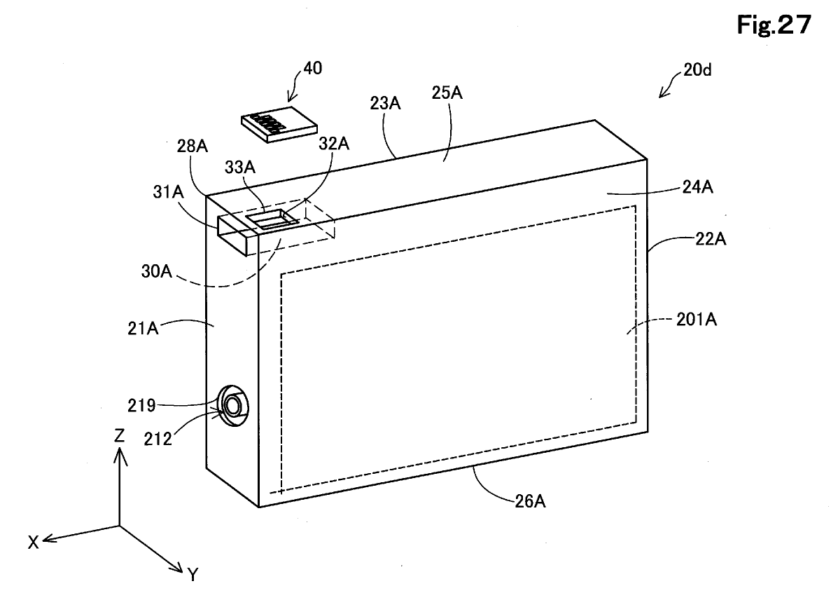

FIG. 27 is an appearance perspective view illustrating the cartridge 20d in the state that the circuit board 40 is detached. As shown in FIG. 27, a through hole 32A is formed in a +Z direction wall (wall including the fifth face 25A) of the outer shell 28A to be pierced in the thickness direction and communicate with the placing portion 30A. An opening 33A is formed in the fifth face 25A to form an end of the through hole 32A. The circuit board 40 is placed on the fifth face 25A such as to close this opening 33A. This configuration causes the second terminal array 42 placed on the rear face S2 of the circuit board 40 to be accessible from the placing portion 30A.

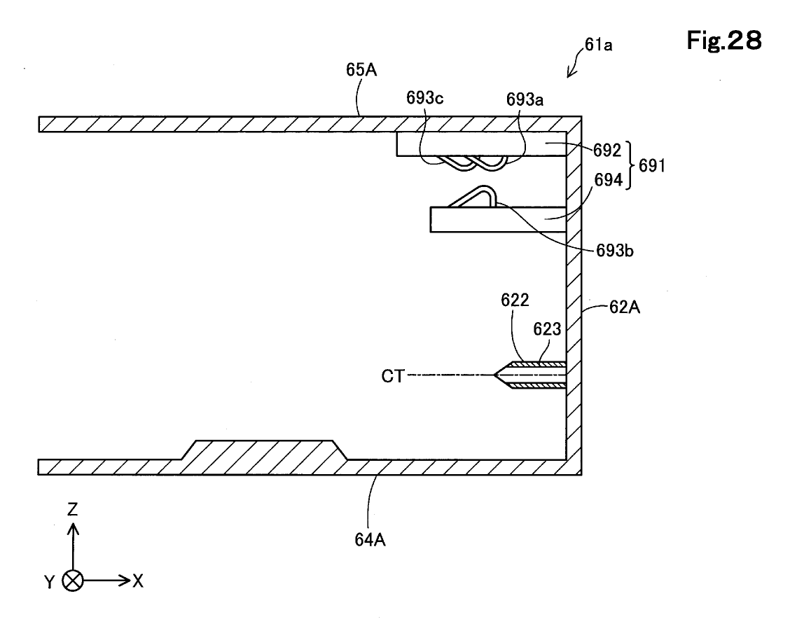

FIG. 28 is a sectional view illustrating the configuration of the holder 61a. FIG. 28 illustrates a B-B section shown in FIG. 25. The cartridge 20d is not mounted to holder 61a in the illustrated state of FIG. 28.

The holder 61a includes a wall portion 62A and two wall portions 64A and 65A that are arranged respectively perpendicular to the wall portion 62A and are opposed to each other and has a box-like appearance shape that is open in the −X direction. The wall portion 64A corresponds to a bottom (vertically lower portion) of the holder 61a. The wall portion 65A corresponds to a top (vertically upper portion) of the holder 61a. Each cartridge 20d is mounted in the +X direction to the holder 61a (to each slot) and is dismounted in the −X direction from the holder 61a.

As shown in FIG. 25, four cartridges 20d are aligned in the Y-axis direction and are placed in the holder 61a. In other words, the four cartridges 20d are mounted to the holder 61a, such that the third face 23A of one cartridge 20d out of two adjacent cartridges 20d is opposed to the fourth face 24A of the other cartridge 20d. In order to allow for such mounting of the cartridges 20d, four slots (mounting spaces) are provided along the Y-axis direction in the holder 61a. The B-B section is a section parallel to an X-Z plane at the center position in the Y-axis direction of one slot among these four slots.

As shown in FIG. 28, each slot includes the ink introducing needle 622 and the electrode assembly 691. The ink introducing needle 622 is inserted into the liquid supply portion 212 of the cartridge 20d in the mounted state. The ink introducing needle 622 has a tapered tubular appearance shape and has a shaft hole 623 that is formed to allow ink to flow inside thereof. The ink introducing needle 622 is arranged to stand in the −X direction from the wall portion 62A. A +X direction end of the ink introducing needle 622, i.e., a portion that adjoins to the wall portion 62A, is connected with a non-illustrated connector for connection with the tube 539. The shaft hole 623 accordingly communicates with the tube 539 by means of this connector.

The electrode assembly 691 is placed at an intersection of the wall portion 62A and the wall portion 65A. The electrode assembly 691 includes an outside electrode holder 692 and an inside electrode holder 694. The outside electrode holder 692 is placed to be in contact with an inner face (top face of the slot) of the wall portion 65A and an inner face of the wall portion 62A. The inside electrode holder 694 is placed away from the outside electrode holder 692 by a predetermined distance in the −Z direction. The inside electrode holder 694 is arranged to stand in the −X direction from the inner face of the wall 62A. The detailed configuration of the outside electrode holder 692 is similar to that of the outside electrode holder 92 of the first embodiment. The outside electrode holder 692 includes first electrodes 693a corresponding to the first electrodes 930a. The outside electrode holder 692 also includes third electrodes 693c corresponding to the third electrodes 930c. The detailed configuration of the inside electrode holder 694 is similar to that of the inside electrode holder 94 of the first embodiment. The inside electrode holder 694 includes second electrodes 693b corresponding to the second electrodes 930b.

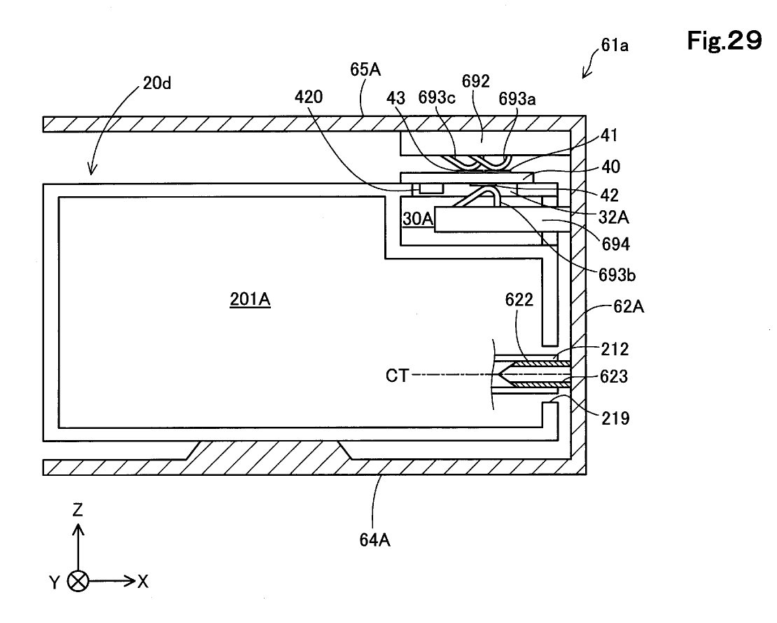

FIG. 29 is a sectional view illustrating the configuration of the cartridge 20d and the holder 61a in the mounted state. FIG. 29 illustrates a section at a similar position to that of the section shown in FIG. 28. The −X direction-side configuration of the liquid supply portion 212 is omitted from the illustration of FIG. 29. In the mounted state, the ink introducing needle 622 is inserted in the liquid supply portion 212. In this state, a center axis CT of the ink introducing needle 622 is aligned with a center axis of the liquid supply portion 212.

In the mounted state, the inside electrode holder 694 is placed in the placing portion 30A. The second electrodes 693b of the inside electrode holder 694 are in contact with the second terminal array 42. The first electrodes 693a are in contact with the first terminal array 41. The third electrodes 693c are in contact with the third terminal array 43.

The cartridge 20d of the second embodiment described above has similar advantageous effects to those of the cartridge 20 of the first embodiment.

### C. Third Embodiment

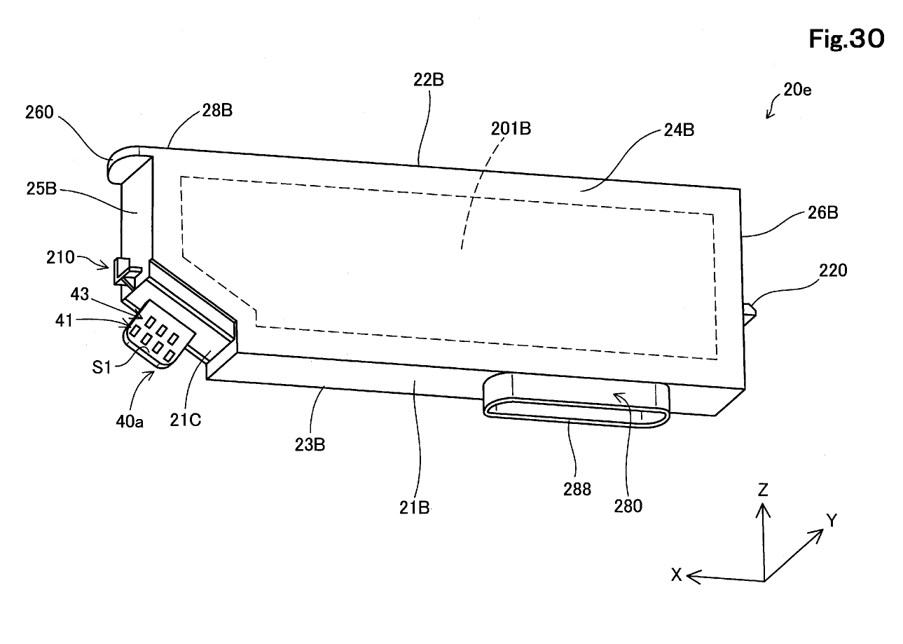

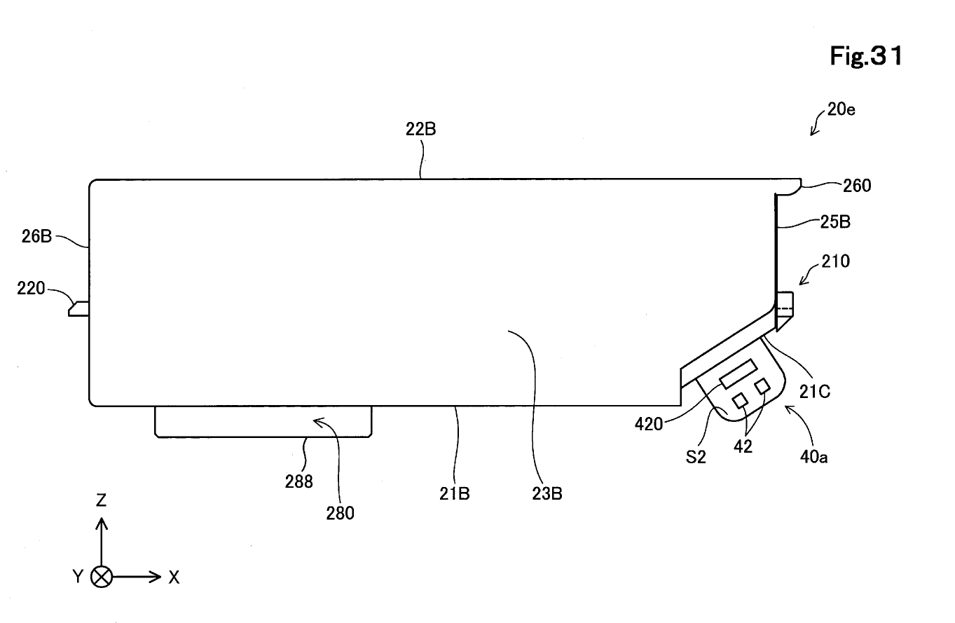

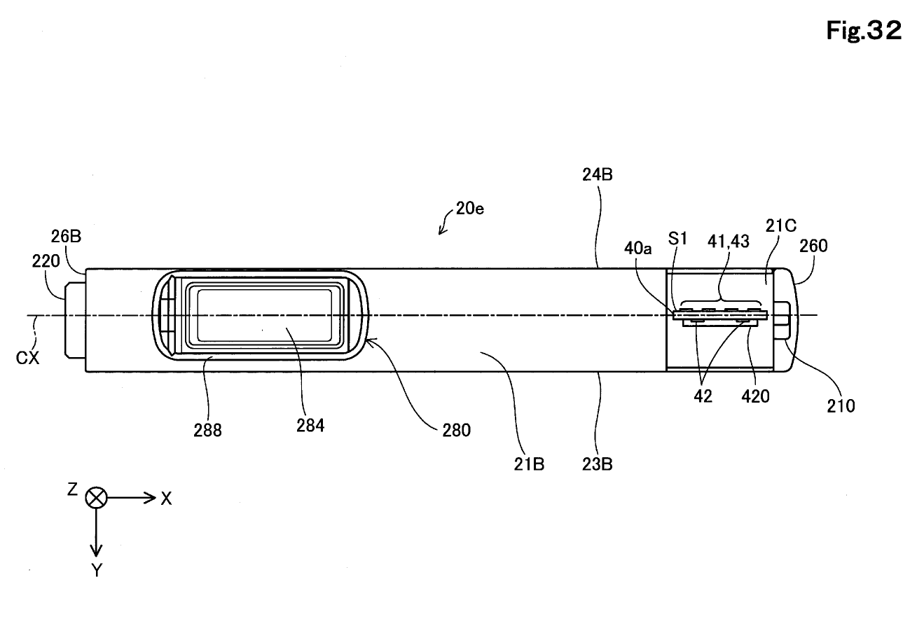

FIG. 30 is a perspective view illustrating an ink cartridge 20e as an application of the liquid supply unit according to a third embodiment of the present disclosure. FIG. 31 is a side view illustrating the cartridge 20e. FIG. 32 is a bottom view illustrating the cartridge 20e.

A printer of the third embodiment differs from the printer 50 of the first embodiment shown in FIG. 1 by the detailed configuration of a carriage and the detailed configuration of a cartridge. Otherwise the configuration of the printer of the third embodiment is similar to the configuration of the printer 50 of the first embodiment. Like components are expressed by like reference signs, and their detailed description is omitted. In FIG. 30, the X axis, the Y axis and the Z axis are shown to clearly show the attitude of the cartridge 20e in the use state. The cartridge 20e is a semi-sealed type ink cartridge, like the ink cartridge 20 of the first embodiment.

The cartridge 20e has an approximately rectangular parallelepiped appearance shape. The cartridge 20e includes an outer shell 28B, a liquid container portion 201B, a liquid supply portion 280, a first restricting portion 210, a second restricting portion 220, an operation projection 260, and a circuit board 40a.

The outer shell 28B includes six faces exposed outside or more specifically has a first face 21B, a second face 22B, a third face 23B, a fourth face 24B, a fifth face 25B and a sixth face 26B. The positional relationship of the respective faces is similar to the positional relationship of the six faces 21 to 26 in the printer 50 of the first embodiment, and its detailed description is omitted. The t of the first face 21B is, however, different from that of the first face 21 of the first embodiment. More specifically, a +X direction end of the first face 21B is formed as a slope face 21C extended in the +Z direction. The first face 21B intersects with the fifth face 25B at this slope face 21C.

The liquid container portion 201B is formed inside of the outer shell 28B to contain ink therein. The liquid supply portion 280 supplies ink that is supplied from the liquid container portion 201B, to a holder 61b described later. The liquid supply portion 280 includes a cylindrical supply opening 288 that adjoins to the first face 21B. As shown in FIG. 32, a thin plate member 284 that is formed in an approximately rectangular shape in planar view is placed at a +Z direction end inside of the supply opening 288. The thin plate member 284 is made of a resin foam. The thin plate member 284 adjoins to an ink supply path that communicates with the liquid container portion 201B to keep the ink supplied from the liquid container portion 201B.

In the mounted state, the first restricting portion 210 comes into contact with a lever 800 of the holder 61b described later to restrict the motion of the cartridge 20e in the Z direction. The first restricting portion 210 is located in a lower portion of the fifth face 25B or more specifically at a position near to an intersection of the fifth face 25B and the slope face 21C to be protruded in the +X direction from the fifth face 25B. In the mounted state, the second restricting portion 220 is inserted in a through hole 620 of the holder 61b described later. The second restricting portion 220 is located in an approximate center potion in the Z-axis direction of the sixth face 26B to be protruded in the −X direction from the sixth face 26B. The operation projection 260 is a portion operated by the user in the process of mounting and dismounting the cartridge 20e. The operation projection 260 is located at a +Z direction end of the fifth face 25B (i.e., at an intersection of the fifth face 25B and the second face 22B) to be protruded in the +X direction.

The circuit board 40a differs from the circuit board 40 of the first embodiment by that its end face is connected with the slope face 21C and that both a surface S1 and a rear face S2 are both exposed outside of the cartridge 20E. Otherwise the configuration of the circuit board 40a is similar to the configuration of the circuit board 40 of the first embodiment. Like components are expressed by like reference signs, and their detailed description is omitted.

As shown in FIG. 32, the circuit board 40a is arranged on the slope face 21C, such that its depth direction is parallel to the Y-axis direction, that the surface S1 and the rear face S2 are parallel to a center axis CX of the cartridge 20e when the cartridge 20e is viewed in the +Z direction, ant that the center in the thickness direction (Y-axis direction) of the circuit board 40a is located on the center axis CX. The center axis CX is an axis that is parallel to the longitudinal direction or the X-axis direction of the cartridge 20e when the cartridge 20e is viewed in the +Z direction and that passes through the center in the short side direction (Y-axis direction) of the cartridge 20e. The surface S1 of the circuit board 40a faces in the −Y direction, and the rear face S2 of the circuit board 40a faces in the +Y direction.

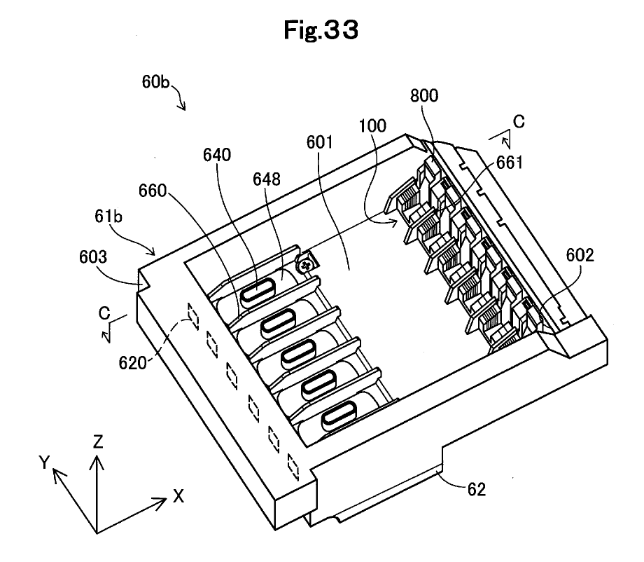

FIG. 33 is a perspective view illustrating the configuration of the carriage 60b according to the third embodiment. The carriage 60 of the third embodiment differs from the carriage 60 of the first embodiment by that the carriage 60b is provided with the holder 61b in place of the holder 61. Otherwise the configuration of the carriage 60b is similar to the configuration of the carriage 60. A like component is expressed by a like reference sign, and its detailed description is omitted. The holder 61b includes a wall portion 601 and two wall portions 602 and 603 that are respectively orthogonal to the wall portion 601 and that are opposed to each other and has a box-like appearance shape that is open in the +Z direction (vertically upward). The wall portion 601 corresponds to a bottom of the holder 61b. The wall portion 602 is placed at a +X direction end of the holder 61b, and the wall portion 603 is placed at a −X direction end of the holder 61b.

Six slots arrayed in the Y-axis direction are formed in the holder 61b, like the carriage 60 of the first embodiment shown in FIG. 10. Through holes 620 are formed in the wall portion 603 at positions corresponding to the respective slots to pass through the wall portion 603 in the thickness direction (X-axis direction). The through holes 620 are formed in a rectangular shape in planar view. The second restricting portion 220 of the cartridge 20e described above is inserted into the through hole 620. Each slot includes a first partition wall 660, a second partition wall 661, an ink receiving tube 640, an elastic member 648, a lever 800, and a holder-side electrode assembly 100.

The first partition wall 660 is placed on a boundary of each slot to part adjacent slots from each other. The first partition wall 660 is arranged at a −X direction end of the wall portion 601 and has a thin plate-like appearance shape arranged to stand in the +Z direction. Similarly, the second partition wall 661 is placed on a boundary of each slot to part adjacent slots from each other. The second partition wall 661 is arranged at a +X direction end of the wall portion 601 and has a thin plate-like appearance shape arranged to stand in the +Z direction.

The ink receiving tube 640 is placed in the wall portion 601 at a position near to the wall portion 603 in each slot. The ink receiving tube 640 has a tubular appearance shape and is arranged to be protruded from the wall portion 601 in the +Z direction. In the mounted state, the ink receiving tube 640 is placed inside of the supply opening 288 of the cartridge 20e described above to abut on the thin plate member 284.

The elastic member 648 has elasticity and is placed to surround the ink receiving tube 640. The elastic member 648 seals the periphery of the liquid supply portion 280 and thereby suppresses leakage of ink from the liquid supply portion 280 in the mounted state. The elastic member 648 applies a biasing force including a +Z direction component to the cartridge 20e.

The lever 800 is placed at a position near to the wall portion 602 in each slot. The lever 800 is a part operated by the user in the process of mounting and dismounting the cartridge 20e. As described later, the lever 800 comes into contact with the first restricting portion 210 of the cartridge 20e in the mounted state.

The holder-side electrode assembly 100 is placed on the wall portion 601 at a position near to the wall portion 602 in each slot. In the mounted state, the holder-side electrode assembly 100 comes into contact with and is electrically connected with respective terminal arrays 41 to 43 of the circuit board 40a. The holder-side electrode assembly 100 has a concave sectional shape to hold the circuit board 40a placed therein in the mounted state.

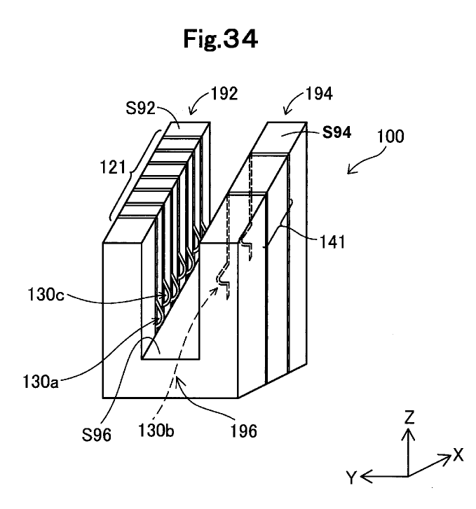

FIG. 34 is a perspective view illustrating the detailed configuration of the holder-side electrode assembly 100 shown in FIG. 33. The holder-side electrode assembly 100 includes a first electrode holder 192, a second electrode holder 194 and a connecting portion 196.

The first electrode holder 192 is configured to place therein an electrode group that comes into contact with the first terminal array 41 and the third terminal array 43 of the circuit board 40a in the mounted state, like the outside electrode holder 92 of the first embodiment. More specifically, first electrodes 130a that come into contact with the first terminal array 41 and third electrodes 130c that come into contact with the third terminal array 43 are placed in slits 121. The first electrodes 130a have a similar configuration to that of the first electrodes 930a of the first embodiment. The third electrodes 130c have a similar configuration to that of the third electrodes 930c of the first embodiment. The slits 121 have a similar configuration to that of the slits 921 of the first embodiment. The first electrode holder 192 has a top face S92 that is formed in a slope shape inclined in the +Z direction toward the +X direction.

The second electrode holder 194 is configured to place therein second electrodes 130b that come into contact with the second terminal array 42 of the circuit board 40a in the mounted state, like the inside electrode holder 94 of the first embodiment. The second electrodes 130b have a similar configuration to that of the second electrodes 930b of the first embodiment. The second electrode holder 194 has a top face S94 that is formed in a slope shape like the top face S92.

The two electrode holders 192 and 194 are arranged away from each other by a predetermined distance in the Y-axis direction, and the electrodes placed in one holder are opposed to the electrodes placed in the other holder. This predetermined distance is approximately equal to the length in the thickness direction of the circuit board 40a. The connecting portion 196 is arranged to connect respective −Z direction parts of the two electrode holders 192 and 194 with each other. The connecting portion 196 has an exposed top face S96 in its center portion that does not adjoin to the two electrode holders 192 and 194. The top face S96 is formed in a slope shape like the top faces S92 and S94 described above. In the mounted state, this top face S96 is opposed to an end face of the circuit board 40a.

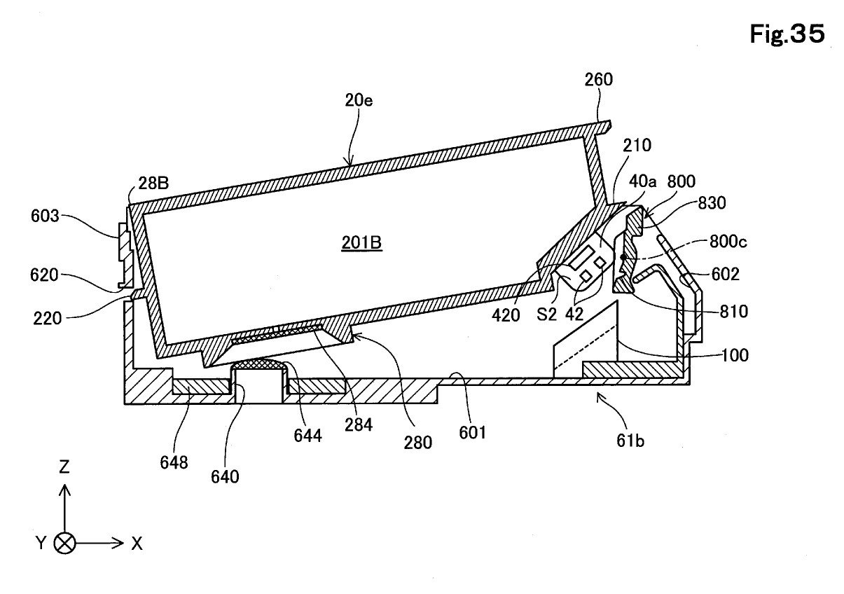

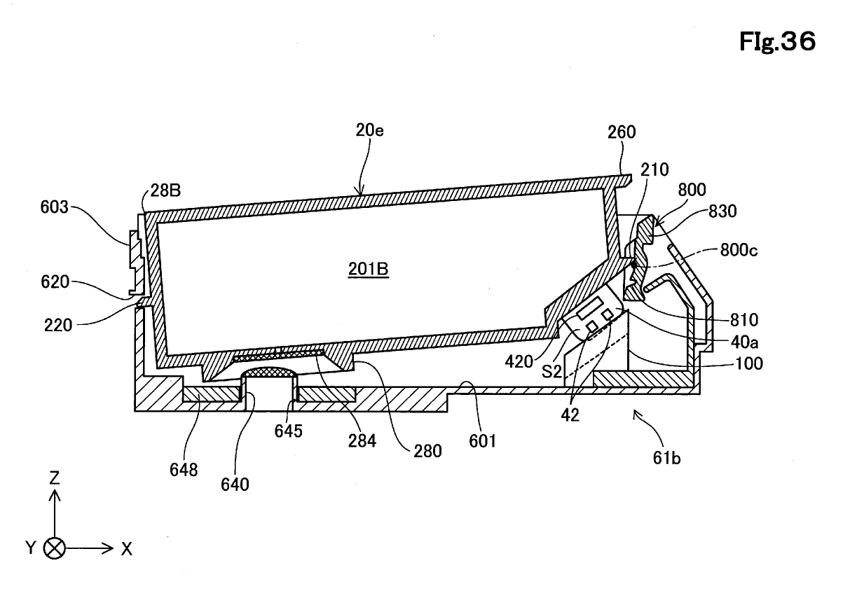

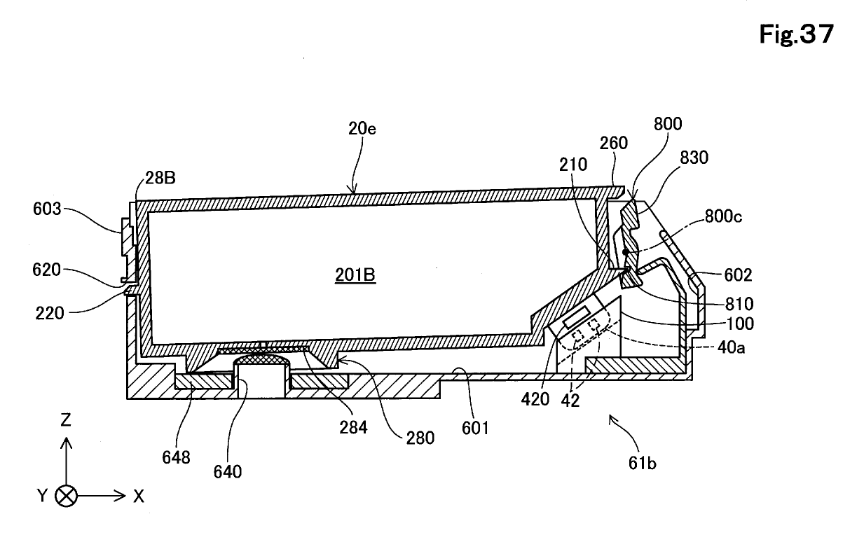

FIG. 35 is a first sectional view illustrating sections of the cartridge 20e and the holder 61a in the process of mounting the cartridge 20e. FIG. 36 is a second sectional view illustrating the sections of the cartridge 20e and the holder 61b in the process of mounting the cartridge 20e. FIG. 37 is a third sectional view illustrating the sections of the cartridge 20e and the holder 61b in the process of mounting the cartridge 20e. A time change in attitude of the components of the cartridge 20e and the holder 61b in the process of mounting the cartridge 20e is shown in the sequence of FIG. 35, FIG. 36 and FIG. 37.

As shown in FIGS. 35 to 37, a porous filter 644 is placed at a leading end (+Z direction end) of the ink receiving tube 640 in the holder 61b. A large number of pores are formed in the porous filter 644 to keep ink therein. The porous filter 644 is arranged to be in contact with the thin plate member 284 in the mounted state.

As shown in FIGS. 35 to 37, the lever 800 of the holder 61b includes an operating part 830, a holder-side restricting portion 810, and an axis 800c. The operating part 830 is a region that is located on a most +Z direction side of the lever 800 and that is operated by the user. The holder-side restricting portion 810 has a groove-like appearance shape provided in the lever 800 and comes into contact with the first restricting portion 210 of the cartridge 20e in the mounted state. The axis 800c serves as an axis of rotation of the lever 800.

In the process of mounting the cartridge 20e, the cartridge 20e is first moved downward toward the slot and is positioned in an inclined attitude shown in FIG. 35 to locate its +X direction slightly upward such that the second restricting portion 220 is inserted into the through hole 620. At this stage, the ink receiving tube 640 of the holder 61b is not yet inserted into the liquid supply portion 280 (supply opening 288). The circuit board 40a is not yet in contact with the holder-side electrode assembly 100.

As shown in FIG. 36, at a next stage, the second restricting portion 220 is inserted into the through hole 620, and the entire cartridge 20e is rotated clockwise. At this stage, an upper part of the ink receiving tube 640 is placed inside of the liquid supply portion 280 (supply opening 288). A lower part of the circuit board 40a is inserted in a space between the first electrode holder 192 and the second electrode holder 194 of the holder-side electrode assembly 100.

As shown in FIG. 37, at a next stage that mounting is almost completed, the second restricting portion 220 is fully inserted in the through hole 620. The ink receiving tube 640 is almost fully placed in the supply opening 288. The porous filter 644 at the leading edge of the ink receiving tube 640 is in contact with the thin plate member 284 of the cartridge 20e. The first restricting portion 210 adjoins to and is engaged with the holder-side restricting portion 810. Engagement of the first restricting portion 210 with the holder-side restricting portion 810 suppresses a positional misalignment, especially, a positional misalignment in the +Z direction, of the cartridge 20e. This configuration accordingly suppresses the cartridge 20e from coming off from the slot.

As shown in FIG. 37, at the stage that mounting is almost completed, the part of the circuit board 40a in which the second terminal array 42 is placed and the part of the circuit board 40a in which the first terminal array 41 and the third terminal array 43 that are not shown in FIG. 37 are placed are inserted into the space between the first electrode holder 192 and the second electrode holder 194 of the holder-side electrode assembly 100. The second terminal array 42 is in contact with the second electrodes 130b. The first terminal array 41 and the third terminal array 43 are respectively in contact with the first electrodes 130a and with the third electrodes 130c.

In the process of dismounting the cartridge 20e from the mounted state, the user moves the operating part 830 of the lever 800 in the +X direction. The lever 800 then rotates clockwise about the axis 800c as the axis of rotation, and the first restricting portion 210 is lifted upward by the holder-side restricting portion 810. The circuit board 40a accordingly separates from the holder-side electrode assembly 100, and the cartridge 20e is rotated about the second restricting portion 220 as the fulcrum to move its +X direction side upward and is dismounted from the slot.

The cartridge 20e of the third embodiment described above has similar advantageous effects to those of the cartridge 20 of the first embodiment.

### D. Modifications of Respective Embodiments

D1. Modification 1

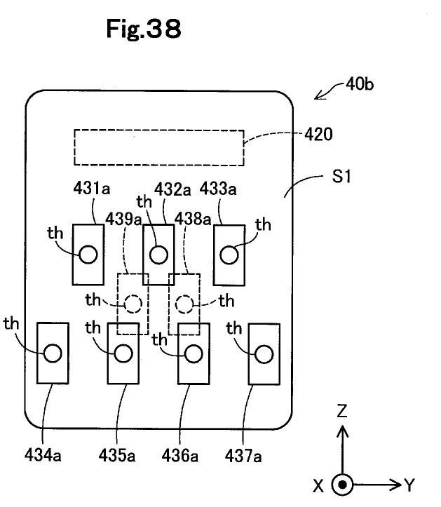

In the respective embodiments, the surfaces of the respective terminals 431 to 439 are formed in an approximately planar shape. The present disclosure is, however, not limited to this configuration. FIG. 38 is a diagram illustrating the configuration of a circuit board 40b according to a modification. FIG. 38 illustrates the circuit board 40b such that a surface S1 of the circuit board 40b faces the front side, like FIG. 15. FIG. 38 shows a rear face S2-side configuration by broken lines.

The circuit board 40b of Modification 1 differs from the circuit board 40 of the first and the second embodiments by that the circuit board 40b is provided with terminals 431a to 439a, in place of the terminals 431 to 439. Otherwise the configuration of the circuit board 40b is similar to the configuration of the circuit board 40. Like components are expressed by like reference signs, and their detailed description is omitted. Each of the terminals 431a to 439a serving as electrically conductive bodies of the circuit board 40b has a through hole th that is formed at the center thereof. This through hole th reaches the substrate of the circuit board 40b.

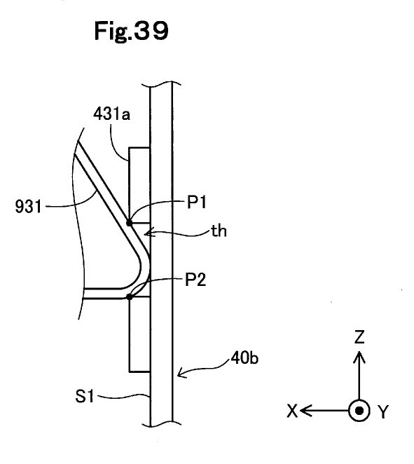

FIG. 39 is a sectional view illustrating closeup of a contact of the terminal 431a and the outside electrode 931 in the mounted state. FIG. 39 illustrates a section parallel to the X-Z plane at a position passing through the through hole th of the terminal 431a.

As shown in FIG. 39, a leading end part (−X direction end part) of a bent portion of the outside electrode 931 is inserted in the through hole th. The terminal 431a is in contact with the outside electrode 931 at two contact points P1 and P2. These two contact points P1 and P2 are points on the circumference of a surface-side opening of the through hole th. The outside electrode 931 has a thickness in the Y-axis direction, so that the contact points P1 and P2 actually denote lines or areas parallel to the Y-axis direction. The other terminals 432a to 439a similarly have two contact points.

A cartridge including the circuit board 40b of this configuration has similar advantageous effects to those of the respective embodiments. The circuit board 40a of the third embodiment may similarly be configured such that through holes th are provided in the respective terminals 431 to 439. In the configuration of the above modification, the two contact points P1 and P2 correspond to the subordinate concept of the first contact portion and the second contact portion in the claims.

D2. Modification 2

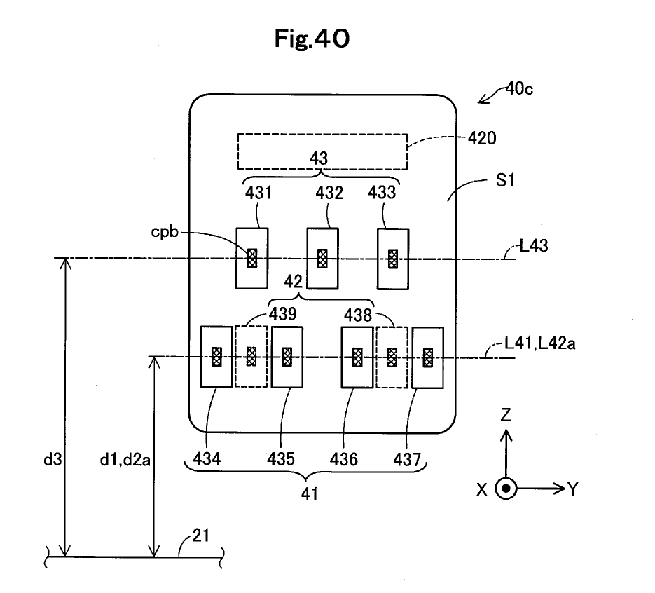

The arrangement of the respective terminals in the circuit boards 40 and 40a of the respective embodiments and in the circuit board 40b of Modification 1 described above is not limited to the arrangements in the above embodiments and in Modification 1. FIG. 40 is a diagram illustrating the configuration of a circuit board 40c according to Modification 2. FIG. 40 illustrates the circuit board 40c such that a surface S1 of the circuit board 40c faces the front side, like FIG. 15 and FIG. 39. FIG. 40 shows a rear face S2-side configuration by broken lines.

The circuit board 40c of Modification 2 differs from the circuit board 40 of the first and the second embodiments by the arrangement of the eighth terminal 438 and the ninth terminal 439. Otherwise the configuration of the circuit board 40c is similar to the configuration of the circuit board 40. Like components are expressed by like reference signs, and their detailed description is omitted.

As shown in FIG. 40, the position of the second terminal array 42 (two terminals 438 and 439) in the circuit board 40c of Modification 2 is lower than the position of the second terminal array 42 in the circuit board 40 of the first embodiment. More specifically, according to Modification 2, the position in the Z-axis direction of the second terminal array 42 in the circuit board 40c is flush with the position in the Z-axis direction of the first terminal array 41 in the circuit board 40c. According to Modification 2, a virtual straight line L42a connecting two contact portions cpb of the second terminal array 42 with each other is aligned with the virtual straight line L41 connecting the four contact portions cpb of the first terminal array 41 with one another. Accordingly, the distance d1 between the first face 21 and the virtual straight line L41 is equal to a distance d2a between the first face 21 and the virtual straight line L42a.

This configuration causes the first electrodes 930a and the second electrodes 930b to apply forces to the circuit board 40c in opposite directions across the circuit board 40 at the same positions in the Z-axis direction when being viewed in the −Y direction. This configuration accordingly cancels at least part of these forces in the circuit board 40c and thereby suppresses a positional misalignment and deformation of the circuit board 40c by these forces. The positions of the eighth terminal 438 and the ninth terminal 439 may be similarly changed in the circuit board 40a of the third embodiment and in the circuit board 40b of Modification 1.

D3. Modification 3

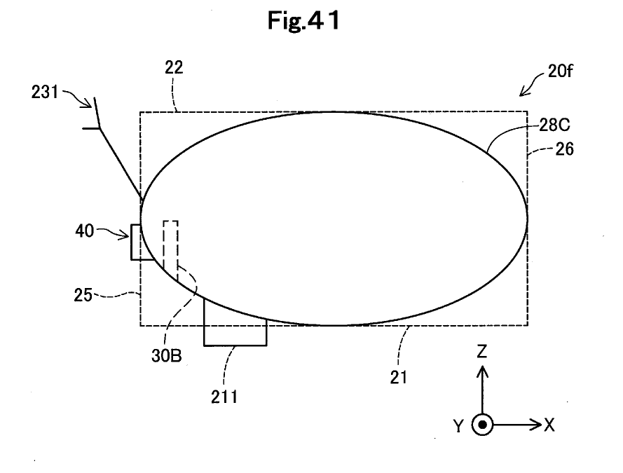

FIG. 41 is a conceptual diagram illustrating a modification of the shape of the cartridge. FIG. 41 illustrates a modification of the cartridge 20 of the first embodiment as an example. In the respective embodiments, the outer shell 28, 28A or 28B of the cartridge 20 or 20a to 20e is formed in the approximately rectangular parallelepiped shape (as shown in FIG. 2, FIG. 26 or FIG. 30). The shape of the outer shell is, however, not limited to these embodiments. The outer shell may be formed in any shape that is mountable to the corresponding holder 61, 61a or 61b. The outer shell 28 of the first embodiment is shown by broken line in FIG. 41.

For example, as shown in FIG. 41, an outer shell 28C has an elliptical or oval side face. A cartridge 20f has a fixed width along the Y-axis direction when being viewed in the +X direction. A liquid supply portion 211 is placed at a position near to a lever 231 on the bottom of the outer shell 28C. A circuit board 40 is placed at a position slightly on a −Z direction side of a −X direction end of the outer shell 28C. The outer shell 28C has a placing portion 30B that is formed between the liquid supply portion 211 and the circuit board 40 and that is open to the surface. The lever 231 is placed at a position slightly on a +Z direction side of the −X direction end of the outer shell 28C.

As described above, as long as the cartridge is compatible with any of the cartridges 20 and 20a to 20e, the shape of the outer shell is not limited to the shapes of the outer shells 28, 28A and 28B of the respective embodiments.

D4. Modification 4

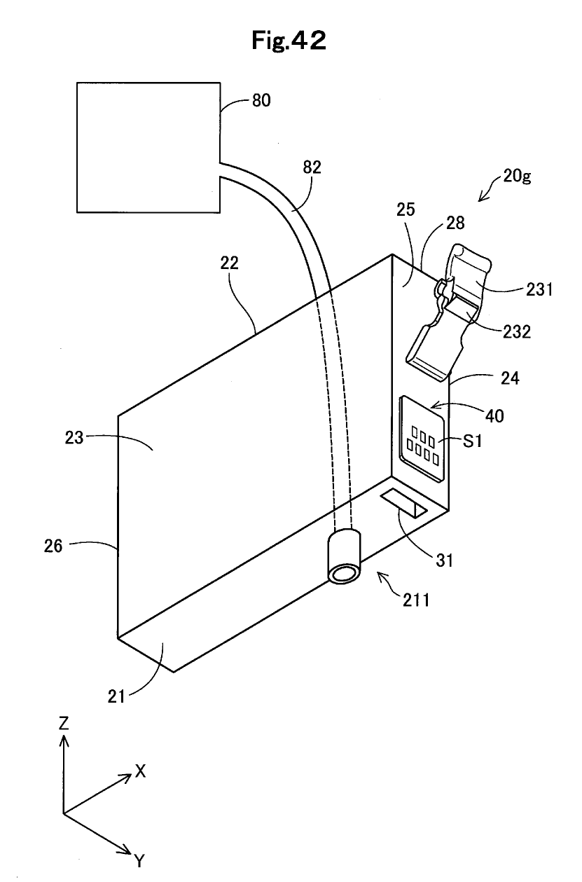

The respective embodiments describe the ink cartridges as the applications of the liquid supply unit of the present disclosure. The present disclosure is, however, not limited to the ink cartridge but may be applied to any liquid supply unit configured to contain ink therein and supply the ink. FIG. 42 is a diagram illustrating the configuration of a liquid supply unit according to a modification. In the respective embodiments, the cartridge 20 or 20a to 20e includes the liquid container portion 201, 201A or 201B placed inside of the outer shell 28, 28A or 28B. The position of the liquid container portion 201, 201A or 201B is, however, not limited to these embodiments. For example, like a liquid supply unit 20g shown in FIG. 42, a tank 80 as a liquid container portion may be placed outside of an outer shell 28. The tank 80 is connected with a liquid supply portion 212 via a tube 82.

D5. Modification 5

In the respective embodiments and the respective modifications, the contact portions (terminals) that come into contact with the electrodes in the holder 61, 61a or 61b are placed on the circuit board 40 or 40a to 40c. The present disclosure is, however, not limited to this configuration. For example, contact portions (terminals) may be directly formed on the surface of the outer shell 28, 28A, 28B or 28C. Such contact portions (terminals) may be provided by forming thin electrically conductive material layers, for example, on the surface of the outer shell 28, 28A, 28B or 28C by sputtering, screen printing or the like. This modified configuration allows for omission of a through hole in the thickness direction used to access the second terminal array 42 on the rear face S2, for example, the through hole 32 of the cartridge 20 of the first embodiment. Accordingly, this modified configuration does not provide the through hole in a corresponding location but forms the first terminal array 41 and the third terminal array 43 on an outside surface of this location and the second terminal array 42 on a placing portion 30-side surface of this location. In general, the wall portion of any configuration where the first contact portion and the second contact portion are placed may be applied to the liquid supply unit of the present disclosure.

D6. Modification 6

In the first embodiment, the opening that causes the placing portion 30 to be accessible is only the opening 31 in the state that the circuit board 40 is attached. In addition to the opening 31, another opening may be provided in at least one of the third face 23 and the fourth face 24. This modified configuration facilitates maintenance, for example, removal of any foreign substance such as dust and ink adhering to inside of the placing portion 30 by using the additionally provided opening. Similarly, an opening may be provided in at least one of the third face 23A and the fourth face 24A in the second embodiment. The additionally provided opening may be extended to a lower end of the outer shell 28 or 28A to communicate with the opening 31 or 31A and form a slit. This modified configuration further facilitates removal of any foreign substance such as dust and ink adhering to inside of the placing portion 30 or 30A.

D7. Modification 7

The number of terminals provided in the circuit board 40 or 40a in the respective embodiments and modifications is not limited to 7 but may be any number that is equal to or larger than 2. For example, the position of the eighth terminal 438 may be changed to the surface S1, so that eight terminals may be placed on the surface S1 and only one terminal (only the ninth terminal 439) may be placed on the rear face S2. In this modified configuration, the ninth terminal 439 that is the only terminal placed on the rear face S2 may be formed on the entire rear face S2. The electrode that is grounded preferably has a lower electrical resistance. This modified configuration meets this requirement. Additionally, the ninth terminal 439 (ground terminal) may serve as an electromagnetic shield to reduce the effect of high frequency wave. In the respective embodiments, the number of terminals placed on the surface S1 may be equal to or smaller than the number of terminals placed on the rear face S2. A terminal of a different application from the application in each of the embodiments may be placed at each terminal location in the embodiment. The numbers of terminals arrays placed on the surface S1 and placed on the rear face S2 may be any numbers.

D8. Modification 8

The configurations of the ink cartridge and the printer in the respective embodiments are only illustrative and may be modified in various ways other than Modifications 1 to 7 described above. For example, according to the first embodiment, the width in planar view (length in the direction parallel to the Y-axis direction) of the inside electrode holder 94 is smaller than the width in planar view of the outside electrode holder 92. According to a modification, the width in planar view of the inside electrode holder 94 may be equal to or larger than the width in planar view of the outside electrode holder 92. The same applies to the second embodiment and the third embodiment. According to the first embodiment, the outside electrode holder 92 and the inside electrode holder 94 are configured by separate members. These electrode holders 92 and 94 may, however, be configured by one member (unit) like the third embodiment. The placing portion 30 is formed in the approximately rectangular parallelepiped shape. The placing portion 30 may, however, be formed in any other shape. This shape may be determined to increase the dimension of a section in a direction perpendicular to the inserting direction of the inside electrode holder 94 with a decrease in distance from the opening 31. This configuration enables the inside electrode holder 94 to be more readily introduced into the placing portion 30. In the second aspect and the third aspect of the modification of the first embodiment, the position in the X-axis direction of the surface S1 of the circuit board 40 is flush with the position in the X-axis direction of the fifth face 25. In other words, the circuit board 40 is placed in the through hole 32a or in the cut 34a in the X-axis direction (thickness direction). The present disclosure is, however, not limited to this configuration. For example, part of the circuit board 40 in the X-axis direction may be exposed from the through hole 32a or from the cut 34a. Accordingly, any configuration may be employed to enable at least part of the circuit board 40 in the thickness direction to be placed in the through hole 32a or in the cut 34a.

D9. Modification 9

The printers 50 and 50a are inkjet printers. The present disclosure may, however, be applied to any liquid ejection apparatus configured to eject a liquid other than ink. For example, the present disclosure may be applied to any of various liquid ejection apparatuses given below:

(1) image recording apparatus such as facsimile machine;

(2) color material ejection apparatus used for manufacturing color filters for image display apparatuses such as liquid crystal displays;

(3) electrode material ejection apparatus used for forming electrodes of, for example, organic EL (electroluminescence) displays and field emission displays (FED);

(4) liquid ejection apparatus configured to eject a bioorganic material-containing liquid used for manufacturing biochips;

(5) sample ejection apparatus used as precision pipette;

(6) ejection apparatus of lubricating oil;

(7) ejection apparatus of resin solutions;

(8) liquid ejection apparatus for pinpoint ejection of lubricating oil on precision machines such as watches and cameras;

(9) liquid ejection apparatus configured to eject transparent resin solutions, such as ultraviolet curable resin solution, onto substrates to manufacture hemispherical microlenses (optical lenses) used for, for example, optical communication elements;

(10) liquid ejection apparatus configured to eject acidic or alkaline etching solutions to etch substrates and the like; and

(11) liquid ejection apparatus equipped with a liquid ejection head configured to eject a very small volume of droplets of any other liquid.

The “droplet” described above means the state of liquid ejected from the liquid ejection apparatus and may be in a granular shape, a teardrop shape or a tapered threadlike shape. The “liquid” herein may be any material ejectable by the liquid ejection apparatus. The “liquid” may be any material in the liquid phase. For example, the “liquid” may be any material in the liquid phase. Liquid-state materials of high viscosity or low viscosity, sols, aqueous gels and other liquid-state materials including inorganic solvents, organic solvents, solutions, liquid resins and liquid metals (metal melts) are included in the “liquid”. The “liquid” is not limited to the liquid state as one of the three states of matter but includes solutions, dispersions and mixtures of the functional solid material particles, such as pigment particles or metal particles, solved in, dispersed in or mixed with solvents. Typical examples of the liquid include ink described in the above embodiments and liquid crystal. The ink herein includes general water-based inks and oil-based inks, as well as various liquid compositions, such as gel inks and hot-melt inks.

The present disclosure is not limited to any of the embodiments and the modifications described above but may be implemented by a diversity of configurations without departing from the scope of the disclosure. For example, the technical features of any of the embodiments and the modifications corresponding to the technical features of each of the aspects described in Summary may be replaced or combined appropriately, in order to solve part or all of the problems described above or in order to achieve part or all of the advantageous effects described above. Any of the technical features may be omitted appropriately unless the technical feature is described as essential herein.

### REFERENCE SIGNS LIST

20, 20a-20f . . . ink cartridge, 20g . . . liquid supply unit, 21, 21A, 21B . . . first face, 21C . . . slope face, 22, 22A, 22B . . . second face, 23, 23A, 23B . . . third face, 24, 24A, 24B . . . fourth face, 25, 25A, 25B . . . fifth face, 26, 26A, 26B . . . sixth face, 28, 28A, 28B, 28C . . . outer shell, 29 . . . wall, 30, 30A, 30B . . . placing portion, 31, 31a, 31A . . . opening, 32, 32a, 32A . . . through hole, 33, 33a, 33b, 33A . . . opening, 34, 34a . . . cut, 40, 40a, 40b, 40c . . . circuit board, 41 . . . first terminal array, 42 . . . second terminal array, 43 . . . third terminal array, 50, 50a . . . printer, 60, 60b . . . carriage, 60a . . . head unit, 61, 61a, 61b . . . holder, 62 . . . print head, 62A . . . wall portion, 64A . . . wall portion, 65A . . . wall portion, 80 . . . tank, 82 . . . tube, 91 . . . holder-side electrode assembly, 92 . . . outside electrode holder, 94 . . . inside electrode holder, 95 . . . ink introducing needle, 96 . . . partition wall, 97 . . . projection, 100 . . . holder-side electrode assembly, 121 . . . slit, 130a . . . first electrode, 130b . . . second electrode, 130c . . . third electrode, 192 . . . first electrode holder, 194 . . . second electrode holder, 196 . . . connecting portion, 201, 201A, 201B . . . liquid container portion, 210 . . . first restricting portion, 211 . . . liquid supply portion, 212 . . . liquid supply portion, 219 . . . supply portion placing hole, 220 . . . second restricting portion, 231 . . . lever, 232 . . . convex portion, 260 . . . operation projection, 280 . . . liquid supply portion, 284 . . . thin plate member, 288 . . . supply opening, 291 . . . lower portion, 321, 321a . . . step, 420 . . . storage unit, 431-439, 431a-439a . . . terminals (first to ninth terminals), 510 . . . controller, 517 . . . flexible cable, 522 . . . carriage motor, 524 . . . drive belt, 529 . . . feed rod, 532 . . . feed motor, 534 . . . platen, 539 . . . tube, 601 . . . wall portion, 602 . . . wall portion, 603 . . . wall portion, 620 . . . through hole, 622 . . . ink introducing needle, 623 . . . shaft hole, 640 . . . ink receiving tube, 644 . . . porous filter, 648 . . . elastic member, 660 . . . wall, 661 . . . wall, 691 . . . electrode assembly, 692 . . . outside electrode holder, 693a . . . first electrode, 693b . . . second electrode, 693c . . . third electrode, 694 . . . inside electrode holder, 800 . . . lever, 800c . . . axis, 810 . . . holder-side restricting portion, 830 . . . operating part, 921 . . . slit, 922 . . . support base, 930a . . . first electrode, 930b . . . second electrode, 930c . . . third electrode, 931-937 . . . outside electrode, 938-939 . . . inside electrode, 941 . . . slit, 942 . . . support base, CT . . . center axis, CX . . . center axis, F1, F2, F3 . . . force, L41, L42, L42a, L43 . . . virtual line, P . . . printing medium, P1 . . . contact point, RP . . . bent point, S1 . . . surface, S2 . . . rear face, S61a . . . wall face, S61b . . . bottom face, S92 . . . top face, S94 . . . top face, S96 . . . top face, cpa . . . contact, cpb . . . contact portion, d1 . . . distance, d2 . . . distance, d2a . . . distance, d3 . . . distance, th . . . through hole

1. A liquid supply unit configured to be mountable to a liquid ejection apparatus that includes a first electrode and a second electrode, the liquid supply unit comprising:
a first contact portion configured to be in contact with the first electrode in a state that the liquid supply unit is mounted to the liquid ejection apparatus;
a second contact portion configured to be in contact with the second electrode in the state that the liquid supply unit is mounted to the liquid ejection apparatus; and
a wall portion configured such that the first contact portion and the second contact portion are placed therein, wherein
the first contact portion is placed on a first wall face of the wall portion, and the second contact portion is placed on a second wall face of the wall portion that is on an opposite side to the first wall face.

2. The liquid supply unit according to claim 1, further comprising:
a liquid container portion, wherein
the second electrode is placed between the liquid container portion and the wall portion in the state that the liquid supply unit is mounted to the liquid ejection apparatus.

3. The liquid supply unit according to claim 1, further comprising:
a first face;
a second face opposed to the first face;
a third face arranged to intersect with the first face and the second face;
a fourth face arranged to intersect with the first face and the second face and opposed to the third face;
a fifth face arranged to intersect with the first face, the second face, the third face and the fourth face;
a sixth face arranged to intersect with the first face, the second face, the third face and the fourth face and opposed to the fifth face;
a liquid supply portion formed on the first face and configured to supply a liquid to the liquid ejection apparatus; and
a restricting portion formed on the fifth face and configured to restrict an attitude of the liquid supply unit in a process of mounting the liquid supply unit to the liquid ejection apparatus, wherein
the wall portion forms at least part of the fifth face, and
when the liquid supply unit is viewed in a direction from the first face toward the second face, the liquid supply portion is located nearer to the fifth face than the sixth face, and the first contact portion and the second contact portion are both located between the liquid supply portion and the restricting portion.

4. The liquid supply unit according to claim 3, further comprising:
a case including the first face to the sixth face, wherein
the case includes a placing portion that is open at least to the first face and that is configured to place the second electrode therein in the state that the liquid supply unit is mounted to the liquid ejection apparatus.

5. The liquid supply unit according to claim 4,
wherein the placing portion is further open to the third face.

6. The liquid supply unit according to claim 5,
wherein the placing portion is further opening to the fourth face.

7. The liquid supply unit according to claim 6,
wherein an opening of the placing portion formed in at least one of the third face and the fourth face is arranged to be continuous with an opening of the placing portion formed in the first face.

8. The liquid supply unit according to claim 4,
wherein the case has a wall that includes a piercing portion formed to be open to the fifth face and to communicate with the placing portion and that forms at least part of the fifth wall,
the wall portion is configured by a circuit board having the first wall face and the second wall face,
at least part of the circuit board in a thickness direction is placed in the piercing portion, and
the first wall face forms part of the fifth face.

9. The liquid supply unit according to claim 4, comprising:
a plurality of the first contact portions, wherein
number of the first contact portions is larger than number of the second contact portions.

10. The liquid supply unit according to claim 4, further comprising:
a storage unit placed on the first wall face, wherein
the second contact portion is used for power supply to the storage unit.

11. The liquid supply unit according to claim 3,
wherein a distance between the first contact portion and the first face is equal to a distance between the second contact portion and the first face in the state that the liquid supply unit is mounted to the liquid ejection apparatus.

12. The liquid supply unit according to claim 3, wherein
the liquid ejection apparatus further includes a third electrode provided in the same side as the side in which the first electrode is provided with respect to the wall portion in the state that the liquid supply unit is mounted to the liquid ejection apparatus,
the wall portion is configured such that a third contact portion is placed therein,
the third contact portion configured to be in contact with the third electrode in the state that the liquid supply unit is mounted to the liquid ejection apparatus, and
when a distance between the first contact portion and the first face, a distance between the second contact portion and the first face, and a distance between the third contact portion and the first face in the state that the liquid supply unit is mounted to the liquid ejection apparatus are respectively expressed as a first distance, a second distance and a third distance, the second distance is larger than the first distance and is smaller than the third distance.

13. The liquid supply unit according to claim 1, further comprising:
a first face;
a second face opposed to the first face;
a third face arranged to intersect with the first face and the second face;
a fourth face arranged to intersect with the first face and the second face and opposed to the third face;
a fifth face arranged to intersect with the first face, the second face, the third face and the fourth face;
a sixth face arranged to intersect with the first face, the second face, the third face and the fourth face and opposed to the fifth face; and
a liquid supply portion formed on the first face and configured to supply a liquid to the liquid ejection apparatus, wherein
the wall portion is placed on the first face, and
the first wall face of the wall portion faces in a direction from the third face toward the fourth face, and the second wall face of the wall portion faces in a direction from the fourth face toward the third face.

14. The liquid supply unit according to claim 13, comprising:
a plurality of the first contact portions, wherein
number of the first contact portions is larger than number of the second contact portions.

15. The liquid supply unit according to claim 13, further comprising:
a storage unit placed on the second wall face, wherein
the second contact portion is used for power supply to the storage unit.

16. The liquid supply unit according to claim 13,
wherein a distance between the first contact portion and the first face is equal to a distance between the second contact portion and the first face in the state that the liquid supply unit is mounted to the liquid ejection apparatus.

17. The liquid supply unit according to claim 13, wherein
the liquid ejection apparatus further includes a third electrode provided in the same side as the side in which the first electrode is provided with respect to the wall portion in the state that the liquid supply unit is mounted to the liquid ejection apparatus,
the wall portion is configured such that a third contact portion is placed therein,
the third contact portion configured to be in contact with the third electrode in the state that the liquid supply unit is mounted to the liquid ejection apparatus, and
when a distance between the first contact portion and the first face, a distance between the second contact portion and the first face, and a distance between the third contact portion and the first face in the state that the liquid supply unit is mounted to the liquid ejection apparatus are respectively expressed as a first distance, a second distance and a third distance, the second distance is larger than the first distance and is smaller than the third distance.
